(19) United States
(12) Patent Application Publication
(10) Pub. No.: US 2009/0300673 A1
(43) Pub. Date: Dec. 3, 2009

(54) Peer- to- peer set-top box system

(75) Inventors: Franck Bachet, Breval (FR); Alex Ashley, Surrey (GB); Trevor Smith, Middlesex (GB); James Geoffrey Walker, Hampshire (GB); Nicholas Ashton Hall, Walton-on-Thames (GB); David Poupon, Conflans Sainte Honorine (FR); Nigel Smith, Surrey (GB)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS Limited, Middlesex (GB)

(21) Appl. No.: 12/308,431

(22) PCT Filed: Jun. 11, 2007
(86) PCT No.: PCT/GB2007/002143

§ 371 Date: Feb. 20, 2009

Related U.S. Application Data
(60) Provisional application No. 60/832,789, filed on Jul. 24, 2006.
(60) Provisional application No. 60/837,833, filed on Aug. 15, 2006.

(51) Int. Cl. H04N 7/167; H04N 7/173; H04N 5/445

(52) U.S. Cl. 725/31; 725/116; 725/110; 725/53; 725/133

(57) ABSTRACT

A content sharing system, for implementation in a requesting peer, to receive at least a part of a chunk from a serving peer, the chunk being part of a content item, the requesting peer being operationally connected to a plurality of peers including the serving peer via a communications network, the content item being media content originally broadcast in a media stream by a Headend to at least some of the peers, the system including a metadata module to receive chunk metadata identifying the location of the chunk based on an identifier in the media stream originally broadcast by the Headend, a content transfer module to request the at least part of the chunk from the serving peer based on the chunk metadata, and receive the at least part of the chunk from the serving peer. Related apparatus and methods are also described.

### RELATED APPLICATION INFORMATION

The present application claims priority from U.S. Provisional Patent Application Ser. No. 60/832,789 of Bachet, et al., filed 24 Jul. 2006, and U.S. Provisional Patent Application Ser. No. 60/837,833 of Bachet, et al., filed 15 Aug. 2006, the disclosures of which is hereby incorporated herein by reference.

### FIELD OF THE INVENTION

The present invention relates to distribution of video content among digital TV subscribers.

### BACKGROUND OF THE INVENTION

In a digital TV environment, personal video recorder (PVR) devices (set-top boxes (STBs) equipped with a hard disk and video recorder features such as play, pause, fast forward and record), generally enable subscribers to schedule, in advance, programs for recording, to be consumed at a later time.

The platform operator typically manages a bouquet of services, and is generally responsible for hosting an infrastructure for delivering content protected by a Conditional Access solution to the subscribers. The platform operator typically: receives content from one or more content providers such that a content provider manages one or more channels in the TV bouquet; ensures the programs' and/or the channels' security (if Conditional Access protection is required); and injects the content into the broadcast system (satellite, terrestrial or cable interface) for reception by the subscribers.

Due to the particularity of a digital TV bouquet, some programs are multi broadcast during a time window (five showings per month, by way of example only). PVR functionality is generally designed to manage the schedules of recording based on the multi broadcast time slots when a record has not been achieved during the selected time slot, for example, but not limited to, a full or partial absence of the broadcast signal, conflict with another scheduled recording with a higher priority, resulting in a non recorded program that the subscriber wanted to record on the DVR hard disk.

Another situation may occur where part of a recording is missing from a recording of a program that is no longer scheduled to be broadcast.

The platform operator generally never stores the programs in a viewer accessible form in long-term storage at the Head-End. If the platform operator did store the programs in a viewer accessible form at the Head-End, it may be possible for subscribers interested in recovering “old content” to be provided a delivery solution on demand.

A possible suggested solution is the use of File Transfer Protocol (FTP). However, FTP has some fatal flaws in that content generally needs to be stored, the amount of storage required is generally very large, a suitable format for download and play generally needs to be provided as well as provision of an up-to-date listing of “old content”.

The following references are also believed to represent the state of the art:

U.S. Pat. No. 6,633,901 to Zuili;

U.S. Pat. No. 6,145,084 to Zuili, et al.;

US Published Patent Application 2002/0138471 of Dutta, et al.;

US Published Patent Application 2002/0138576 of Schleicher, et al,;

US Published Patent Application 2002/0184357 of Traversat, et al.;

US Published Patent Application 2003/0225709 of Ukita;

US Published Patent Application 2003/0237097 of Marshall, et al.;

US Published Patent Application 2003/0122966 of Markman, et al.;

US Published Patent Application 2003/0177495 of Needham, et al.;

US Published Patent Application 2004/0148353 of Karaoguz, et al.;

US Published Patent Application 2004/0258390 of Olson;

US Published Patent Application 2004/0101271 of Boston, et al.;

US Published Patent Application 2004/0034865 of Barret, et al.;

US Published Patent Application 2004/0163130 of Gray, et al.;

US Published Patent Application 2004/0236863 of Shen, et al.;

US Published Patent Application 2005/0071568 of Yamamoto, et al.;

US Published Patent Application 2005/0177624 of Oswald, et al;

US Published Patent Application 2005/0259607 of Xiong, et al.;

US Published Patent Application 2006/0050697 of Li, et al.;

US Published Patent Application 2006/0085385 of Foster, et al.;

US Published Patent Application 2006/0080454 of Li;

US Published Patent Application 2006/0190615 of Panwar, et al.;

European Published Patent Application EP 1 427 170 of Microsoft Corporation;

European Published Patent Application EP 1 452 978 of Microsoft Corporation;

PCT Published Patent Application WO 01/50755 of NDS Limited;

PCT Published Patent Application WO 01/74076 of COPPE/UFRJ;

PCT Published Patent Application WO 01/99370 of NDS Limited;

PCT Published Patent Application WO 02/05064 of Yen;

PCT Published Patent Application WO 03/071800 of Koninklijke Philips Electronics N.V.;

PCT Published Patent Application WO 2005/091773 of Liberate Technologies;

PCT Published Patent Application WO 2005/076616 of Koninklijke Philips Electronics N.V.;

PCT Published Patent Application WO 2005/067289 of Koninklijke Philips Electronics N.V.;

PCT Published Patent Application WO 2005/091585 of Code-mate ApS;

PCT Published Patent Application WO 2005/107218 of Docomo Communications Laboratories Europe GMBH;

PCT Published Patent Application WO 2006/016297 of Koninklijke Philips Electronics N.V.;

PCT Published Patent Application WO 2006/062964 of Hewlett-Packard Development Company, L.P.;

Japanese Patent Extract JP2003-309600 of Bios:KK;

Korean Patent Extract KR2005001639 of KT Corp.;

Description of Kazza v3.2.5 from Kazaa.com;

Description of Kontiki from Kontiki.com;

Gnutella peer-to-peer referenced in Gnutella.com;

Description of BBC iMP service from informity.com;

Description of Guardian Monitor Family Edition from Guardian Software;

Definitions of “Peer To Peer”, “BitTorrent” and “Digital Video Recorder” on wikipedia.org; and

Article entitled “Incentives Build Robustness in BitTorrent” by Bram Cohen, 22 May 2003 at www.bittorrent.com/bittorrentecon.pdf.

The disclosures of all references mentioned above and throughout the present specification, as well as the disclosures of all references mentioned in those references, are hereby incorporated herein by reference.

### SUMMARY OF THE INVENTION

The present invention seeks to provide an improved system for sharing non bit-identical content for example, but not limited to sharing “previously transmitted” among digital TV subscribers.

The present invention, in preferred embodiments thereof, utilizes the popularity and rapid adoption of broadband connections at home to interface STBs with the Internet in order to provide a peer to peer content sharing network between connected STBs for exchanging content recorded by the STBs. The content sharing network is preferably under the platform operator control.

By way of introduction, a PVR device is typically able to record programs received by a broadcast tuner (for example, but not limited to, DVB-S, DVB-T, DVB-C or TV over Digital Subscriber Line (DSL) source). Generally, one or more PVRs in a platform operator domain have recorded a particular content item. The PVRs may then act as sources for feeding other PVRs requesting the particular content item. Each PVR device is typically connected to a broadband bi-directional channel Internet connection in order to create a peer-to-peer network for sharing content. Generally, no platform operator specific infrastructure in terms of network resources is required to enable sharing of the content.

The system of the present invention, in preferred embodiments thereof, allows non bit-identical, typically encrypted, content (for example, but not limited to, independent recordings made from a satellite, cable, terrestrial or IP broadcast) to be shared among STBs in a peer-to-peer network. By way of example only, due to reception errors of a broadcast DVB transport stream or start/end time of recording, the recording is generally different between any two PVR devices generally making the recordings on the different devices non-bit identical.

The system of the present invention, in preferred embodiment thereof, includes an optimization improving the content sharing distribution by introducing super-nodes into the peer-to-peer network in order to enhance the download time.

Additionally, the system of the present invention, in preferred embodiments thereof, allows the platform operator to control the content that is allowed to be shared among the STBs of the peer-to-peer network and/or to control the period of time during which sharing may take place. The enforcement of rights protection is preferably handled by existing technologies such as a suitable conditional access or DRM system.

In one embodiment of the present invention, access to previously transmitted content is provided using the peer-to-peer network. A “previously transmitted program”, as used in the specification and claims, is defined as a program with a start time anterior to the current time. A subscriber may request the system to obtain a recording of a previously transmitted program from one or more STBs in the peer-to-peer network. Therefore, it is possible to share “previously transmitted program” content recorded on STB hard disks via the Peer-to-Peer network.

Additionally, the system of the present invention, in preferred embodiments thereof, typically includes the following features using the existing Conditional Access or DRM system as a way to ensure content rights protection; enriching the viewer experience with new services such as recovery of previously transmitted programs; automatic completion of personal recorded programs with missing and/or bad segments, content self healing and offering the platform operator new ways of pushing content in an efficient way.

There is thus provided in accordance with a preferred embodiment of the present invention a content sharing system, for implementation in a requesting peer, to receive at least a part of a first chunk from a first serving peer, the first chunk being part of a content item, the requesting peer being operationally connected to a plurality of peers including the first serving peer via a communications network, the first serving peer being associated with a storage arrangement in which the first chunk is stored, the content item being media content originally broadcast in a media stream by a Headend to at least some of the plurality of peers, the system including a metadata module to receive chunk metadata identifying the location of the first chunk based on an identifier in the media stream originally broadcast by the Headend, and a content transfer module operationally connected to the metadata module, the content transfer module being operative to request the at least part of the first chunk from the first serving peer based on the chunk metadata, and receive the at least part of the first chunk from the first serving peer.

Further in accordance with a preferred embodiment of the present invention the peers include a second serving peer, the second serving peer being associated with a storage arrangement in which the first chunk is stored, the content transfer module being operative to request another part of the first chunk from the second serving peer based on the chunk metadata, and receive the other part of the first chunk from the second serving peer.

Still further in accordance with a preferred embodiment of the present invention the peers include a second serving peer, the second serving peer having a storage arrangement in which a second chunk of the content item is stored, the metadata module being operative to receive chunk metadata identifying the location of the second chunk based on the identifier in the media stream originally broadcast by the Headend, the content transfer module being operative to request at least part of the second chunk from the second serving peer based on the chunk metadata, and receive the at least part of the second chunk from the second serving peer.

Further in accordance with a preferred embodiment of the present invention, at least part of the content item is included in a recording in the storage arrangement of the first serving peer, at least part of the content item is included in a recording in the storage arrangement of the second serving peer, and the recording of the first serving peer is different from the recording of the second serving peer based on a bit-to-bit comparison.

Additionally in accordance with a preferred embodiment of the present invention the content item stored in the storage arrangement of at least one of the first serving peer and the second serving peer is recorded from the media stream broadcast by the Headend.

Moreover in accordance with a preferred embodiment of the present invention the identifier is at least one of the following an entitlement control message, a program clock reference, a group of pictures timecode, and an RTS timecode.

Further in accordance with a preferred embodiment of the present invention the first chunk is at least partially encrypted, the identifier not being encrypted.

Still further in accordance with a preferred embodiment of the present invention once the first chunk is received, the content transfer module is able to serve the first chunk to the other peers.

Additionally in accordance with a preferred embodiment of the present invention the content transfer module is operative to receive the at least part of the first chunk from the first serving peer while the content item is still being received by the first serving peer from the Headend.

Moreover in accordance with a preferred embodiment of the present invention the communications network is an Internet protocol network.

Further in accordance with a preferred embodiment of the present invention the metadata module is operative to receive index metadata from the first serving peer, the system further including an indexer operationally connected to the metadata module, the indexer being operative to build, based on the index metadata, a random access index to at least part of the content item received by the content transfer module.

Still further in accordance with a preferred embodiment of the present invention the requesting peer is associated with a storage arrangement having a subscriber section and an operator section, the subscriber section being operative to store the content item, wherein the system includes a deletion module operative to transfer the content item from the subscriber section to the operator section when a subscriber of the requesting peer requests to delete the content item.

Additionally in accordance with a preferred embodiment of the present invention the content item has a sharing expiration date, the deletion module being operative to delete the content item from the operator section on, or after, the sharing expiration date.

Moreover in accordance with a preferred embodiment of the present invention, the system includes an interactive search application to search for the content item based on event information data received in the media stream broadcast by the Headend.

Further in accordance with a preferred embodiment of the present invention the requesting peer is operative to receive the content item in the media stream broadcast by the Headend so that the content item is recordable by the requesting peer, the requesting peer is associated with a storage arrangement to store at least part of the content item, the system further includes a correction sub-system to identify a bad/missing chunk of the content item, the first chunk being a replacement for the bad/missing chunk, the correction sub-system being operationally connected to the content transfer module, the content transfer module is operative to receive the first chunk from at least one of the peers, and the correction sub-system is operative to add the first chunk to the at least part of the content item stored in the storage arrangement associated with the requesting peer.

Still further in accordance with a preferred embodiment of the present invention the correction sub-system is operative to automatically suggest, to a subscriber, recovery of the bad/missing chunk from at least one of the peers.

Additionally in accordance with a preferred embodiment of the present invention the missing chunk was not recorded by the requesting peer from the media stream broadcast by the Headend.

Moreover in accordance with a preferred embodiment of the present invention the bad chunk was received with an error by the requesting peer from the media stream broadcast by the Headend.

Further in accordance with a preferred embodiment of the present invention the requesting peer started recording the content item after the beginning of the content item, resulting in the missing chunk at the beginning of the content item.

Still further in accordance with a preferred embodiment of the present invention the requesting peer stopped recording the content item before the end of the content item, resulting in the missing chunk at the end of the content item.

Additionally in accordance with a preferred embodiment of the present invention the content item is a pushed content item, pushed by the Headend, the missing chunk not being recorded by the requesting peer from the media stream broadcast by the Headend.

There is also provided in accordance with still another preferred embodiment of the present invention a content sharing system, for implementation in a requesting peer, to receive a first chunk from a first serving peer and a second chunk from a second serving peer, the first chunk and the second chunk being part of a content item, the requesting peer being operationally connected to a plurality of peers via a communication network, the peers including the first serving peer and the second serving peer, the first serving peer being associated with a storage arrangement which has a recording including at least part of the content item, the second serving peer being associated with a storage arrangement which has a recording including at least part of the content item, the recording of the first serving peer is different from the recording of the second serving peer based on a bit-to-bit comparison, the content item being media content originally broadcast in a media stream by a Headend to at least some of the plurality of the peers, the system including a content transfer module to request the first chunk from the first serving peer and the second chunk from the second serving peer, and receive the first chunk from the first serving peer and the second chunk from the second serving peer.

There is also provided in accordance with still another preferred embodiment of the present invention a content sharing system, for implementation in a serving peer, to transfer at least a part of a first chunk to a requesting peer, the first chunk being part of a content item, the serving peer being operationally connected to a plurality of peers including the requesting peer via a communications network, the serving peer being associated with a storage arrangement in which the first chunk is stored, the content item being media content originally broadcast in a media stream by a Headend to at least some of the plurality of the peers, the system including a metadata module to receive chunk metadata identifying the location of the first chunk based on an identifier in the media stream originally broadcast by the Headend, a content transfer module operationally connected to the metadata module, the content transfer module being operative to receive a request to transfer the at least part of the first chunk to the requesting peer based on the chunk metadata, and transfer the at least part of the first chunk to the requesting peer.

Moreover in accordance with a preferred embodiment of the present invention the content item stored in the storage arrangement of the serving peer was recorded from the media stream broadcast by the Headend.

Further in accordance with a preferred embodiment of the present invention the identifier is based on at least one of the following an entitlement control message, a program clock reference, a group of pictures timecode, and an RTS timecode.

Still further in accordance with a preferred embodiment of the present invention the content transfer module is operative to transfer the at least part of the first chunk to the requesting peer while the content item is still being received by the serving peer from the Headend.

Additionally in accordance with a preferred embodiment of the present invention the communications network is an Internet protocol network.

Moreover in accordance with a preferred embodiment of the present invention the serving peer is associated with a storage arrangement having a subscriber section and an operator section, the subscriber section being operative to store the content item, wherein the system includes a deletion module operative to transfer the content item from the subscriber section to the operator section when a subscriber of the serving peer requests to delete the content item.

Further in accordance with a preferred embodiment of the present invention the content item has a sharing expiration date, the deletion module being operative to delete the content item from the operator section on, or after, the sharing expiration date.

There is also provided in accordance with still another preferred embodiment of the present invention a system for enabling sharing of a content item among a plurality of peers, the peers being operationally connected via a communications network, the content item being media content originally broadcast in a media stream by a Headend to at least some of the plurality of the peers, the system including a content monitor to create a chunk metadata file which logically divides the content item into a plurality of chunks, such that each of the chunks is identified based on an identifier in the media stream originally broadcast by the Headend, the chunk metadata file being a separate file from the content item.

Still further in accordance with a preferred embodiment of the present invention, the system includes a server, operationally connected to the content monitor and the peers, to serve the chunk metadata to the peers.

Additionally in accordance with a preferred embodiment of the present invention the content monitor is operative to forward the chunk metadata for inclusion in the media stream being broadcast by the Headend.

There is also provided in accordance with still another preferred embodiment of the present invention a system for enhancing sharing of a content item among a plurality of peers including a plurality of super-nodes, the peers being operationally connected via a communications network, the content item being media content originally broadcast in a media stream by a Headend to at least some of the plurality of the peers, the system including a statistics module to determine how many of the peers recorded the content item from the media stream broadcast by the Headend, and a super-node populator to effect population of the super-nodes with the content item after the broadcast of the content item by the Headend.

Moreover in accordance with a preferred embodiment of the present invention the super-node populator is operative to effect population of the super-nodes if a certain number of the peers have not recorded the content item from the media stream.

Further in accordance with a preferred embodiment of the present invention the super-node populator is operative to effect population of the super-nodes by pushing the content to the super-nodes via another media stream broadcast by the Headend.

Still further in accordance with a preferred embodiment of the present invention the super-node populator is operative to effect population of the super-nodes by initiating a peer-to-peer recovery of the content item by the super-nodes from at least one of the peers via the communications network.

There is also provided in accordance with still another preferred embodiment of the present invention a content sharing system for implementation in a serving peer, the serving peer being operationally connected to a plurality of other peers via a communications network, the system including a content transfer module to transfer content between the serving peer and the other peers, and a bandwidth allocation module to limit the time availability of the content transfer module to serve the content to the other peers.

There is also provided in accordance with still another preferred embodiment of the present invention a content sharing system for implementation in a serving peer being operationally connected to a plurality of other peers via a communications network, the system including a content transfer module to transfer content between the serving peer and the other peers, a IPTV service module for receiving an IPTV service via the communications network, and a bandwidth allocation module to decrease a download bandwidth allocated to the content transfer module when the IPTV service module is receiving the IPTV service.

There is also provided in accordance with still another preferred embodiment of the present invention a electronic program guide system, including an RSS reader application operative to link to an RSS feed having content item information for content items available for sharing among a plurality of peers, check the RSS feed to see if the feed has new content item information since the last time the RSS feed was checked by the RSS reader, retrieve the new content item information, and present the new content item information in an electronic program guide.

Additionally in accordance with a preferred embodiment of the present invention the content items were previously broadcast by a Headend to the peers.

There is also provided in accordance with still another preferred embodiment of the present invention a guide server system to provide information about a plurality of content items to a plurality of peers, the content items being media content, the peers being connected via a communication network, the system including a content database to store data about the content items, and a search engine module, operationally connected to the content database, the search engine module being operative to receive a search request from one of the peers, search the content database based on the search request yielding a plurality of results including a first one of the content items and a second one of the content items, the first content item being a program having a default language, the second content item being the same program having a-different default language, select from the results one of the content items that has been shared the most among the peers, and send the data about the most shared content item to the one peer.

There is also provided in accordance with still another preferred embodiment of the present invention a system for pushing at least one segment of a content item to a peer, the peer being operationally connected to a plurality of serving peers via a communications network, the content item being media content, the system including a Headend to send a push request to the peer in order for the peer to initiate a peer-to-peer download of the at least one segment of the content item via the communications network from the serving peers.

Moreover in accordance with a preferred embodiment of the present invention the serving peers include virtual serving peers, the Headend being operative to populate the virtual serving peers with at least part of the content item.

Further in accordance with a preferred embodiment of the present invention each of the virtual serving peers is associated with a location, the Headend being operative to seed a tracker with the locations of the virtual serving peers.

There is also provided in accordance with still another preferred embodiment of the present invention a content sharing system for implementation in a peer for pushing at least one segment of a content item to the peer, the peer being operationally connected to a plurality of serving peers via a communications network, the content item being media content, the system including a receiver to receive a push request, and a content transfer module to download the at least one segment of the content item via the communications network from the serving peers.

There is also provided in accordance with still another preferred embodiment of the present invention a personal computer system, for implementation in a home network, to provide peer-to-peer services in the home network, the home network including at least one set-top box and a storage device, the home network being operationally connected to a plurality of peers via a communications network, the peers being external to the home network, the system including a home network interface to receive a peer-to-peer service command from the at least one set-top box to recover a media content item from among the peers, and a content transfer module, operationally connected to the home network interface, the content transfer module being operative to recover the content item from among the peers, and transfer the content item to the storage device for storage therein.

There is also provided in accordance with still another preferred embodiment of the present invention a method for managing access to a content item among a plurality of peers operationally connected via a communications network, access control to the content item being subject to a first business scenario when the content item is received from a broadcast media stream, the method including determining at least one new business scenario, and associating the at least one new business scenario to the content item in order to define access control to the content item when the content item is shared among the peers via the communications network.

Still further in accordance with a preferred embodiment of the present invention, the method includes generating at least one set of entitlement control messages for the content item for the at least one new business scenario.

There is also provided in accordance with still another preferred embodiment of the present invention a method for sharing a plurality of content items among a plurality of peers, the peers being operationally connected via a communications network, each of the content items associated with one of a plurality of TV channels, the content items being originally broadcast in a media stream by a Headend, the method including defining a plurality of different sharing rules, each of the sharing rules describing how an associated one of the content items is allowed to be shared among the peers, and assigning one of the sharing rules to one of the TV channels and another one of the sharing rules to another one of the TV channels, so that the content items of the one channel are subject to the one sharing rule and the content items of the other channel are subject to the other sharing rule.

There is also provided in accordance with still another preferred embodiment of the present invention a content sharing method, for implementation in a requesting peer, to receive at least a part of a chunk from a serving peer, the chunk being part of a content item, the requesting peer being operationally connected to a plurality of peers including the serving peer via a communications network, the serving peer being associated with a storage arrangement in which the chunk is stored, the content item being media content originally broadcast in a media stream by a Headend to at least some of the plurality of peers, the method including receiving chunk metadata identifying the location of the chunk based on an identifier in the media stream originally broadcast by the Headend, requesting the at least part of the chunk from the serving peer based on the chunk metadata, and receiving the at least part of the chunk from the serving peer.

There is also provided in accordance with still another preferred embodiment of the present invention a content sharing method, for implementation in a requesting peer, to receive a first chunk from a first serving peer and a second chunk from a second serving peer, the first chunk and the second chunk being part of a content item, the requesting peer being operationally connected to a plurality of peers via a communication network, the peers including the first serving peer and the second serving peer, the first serving peer being associated with a storage arrangement which has a recording including at least part of the content item, the second serving peer being associated with a storage arrangement which has a recording including at least part of the content item, the recording of the first serving peer is different from the recording of the second serving peer based on a bit-to-bit comparison, the content item being media content originally broadcast in a media stream by a Headend to at least some of the plurality of the peers, the method including requesting the first chunk from the first serving peer and the second chunk from the second serving peer, and receiving the first chunk from the first serving peer and the second chunk from the second serving peer.

There is also provided in accordance with still another preferred embodiment of the present invention a content sharing method, for implementation in a serving peer, to transfer at least a part of a chunk to a requesting peer, the chunk being part of a content item, the serving peer being operationally connected to a plurality of peers including the requesting peer via a communications network, the serving peer being associated with a storage arrangement in which the chunk is stored, the content item being media content originally broadcast in a media stream by a Headend to at least some of the plurality of the peers, the method including receiving chunk metadata identifying the location of the chunk based on an identifier in the media stream originally broadcast by the Headend, receiving a request to transfer the at least part of the chunk to the requesting peer based on the chunk metadata, and transferring the at least part of the chunk to the requesting peer.

There is also provided in accordance with still another preferred embodiment of the present invention a method for enabling sharing of a content item among a plurality of peers, the peers being operationally connected via a communications network, the content item being media content originally broadcast in a media stream by a Headend to at least some of the plurality of the peers, the method including receiving the content item, and creating a chunk metadata file which logically divides the content item into a plurality of chunks, such that each of the chunks is identified based on an identifier in the media stream originally broadcast by the Headend, the chunk metadata file being a separate file from the content item.

There is also provided in accordance with still another preferred embodiment of the present invention a method for enhancing sharing of a content item among a plurality of peers including a plurality of super-nodes, the peers being operationally connected via a communications network, the content item being media content originally broadcast in a media stream by a Headend to at least some of the plurality of the peers, the method including determining how many of the peers recorded the content item from the media stream broadcast by the Headend, and effecting population of the super-nodes with the content item after the broadcast of the content item by the Headend.

There is also provided in accordance with still another preferred embodiment of the present invention a content sharing method for implementation in a serving peer being operationally connected to a plurality of other peers via a communications network, the method including transferring content between the serving peer and the other peers, receiving an IPTV service via the communications network, and decreasing a download bandwidth allocated to the content transfer when the IPTV service is being received.

There is also provided in accordance with still another preferred embodiment of the present invention a electronic program guide method, including linking to an RSS feed having content item information for content items available for sharing among a plurality of peers, checking the RSS feed to see if the feed has new content item information since the last time the RSS feed was checked, retrieving the new content item information, and presenting the new content item information in an electronic program guide.

There is also provided in accordance with still another preferred embodiment of the present invention a method for providing information about a plurality of content items to a plurality of peers, the content items being media content, the peers being connected via a communication network, the method including storing data about the content items, receiving a search request from one of the peers, searching the data based on the search request yielding a plurality of results including a first one of the content items and a second one of the content items, the first content item being a program having a default language, the second content item being the same program having a different default language, selecting from the results one of the content items that has been shared the most among the peers, and sending the data about the most shared content item to the one peer.

There is also provided in accordance with still another preferred embodiment of the present invention a content sharing method for implementation in a peer for pushing at least one segment of a content item to the peer, the peer being operationally connected to a plurality of serving peers via a communications network, the content item being media content, the method including receiving a push request, and downloading the at least one segment of the content item via the communications network from the serving peers.

The acronyms used herein are defined in the following list:

AES—Advanced Encryption Standard;

AMS—Audience Measurement System;

APG—Advanced Program Guide which is an over-the-air encoding used for schedule information;

CA—Conditional Access;

CAS—Conditional Access System including components in the STB and the head-end that deal with conditional access (CA), for example, but not limited to, head-end components such as the EMMG (ACC) and ECMG (BCC);

CWP—Control Word Packet which is part of the conditional access system used by platforms based on the DSS transport;

DES—Data-Encryption Standard;

DHCP—Dynamic Host Configuration Protocol;

DRM—Digital Rights Management;

DSL—Digital Subscriber Line which is a family of technologies that provide digital data transmission over the wires of a local telephone network;

DSM-CC—Digital Storage Media Command and Control;

DSS—DIRECTV transport protocol;

DVB—Digital Video Broadcasting standard;

DVR—Digital Video Recorder;

ECM—Entitlement Control Message which is part of the conditional access system used by platforms based on MPEG-2 transport streams;

EIT—Event Information Table;

EPG—Electronic Program Guide;

ESS—Event Synchronization System;

FEC—Forward Error Correction;

GOP—Group of Pictures;

KWT—Keyword table;

IP—Internet Protocol;

MFTP—Multicast File Transfer Protocol;

NAS—Network attached storage;

NSA—Native Scrambling Algorithm;

P2P—Peer To Peer;

PAT—Program Association Table which is an MPEG-2 table used to describe all the services within a transport stream;

PC—Personal Computer;

PCR—Program Clock Reference which is a 42 bit clock sample running at 27 mega Hertz that is inserted in to an MPEG-2 transport stream to enable service components, such as video and audio, to be synchronized, in some systems the PCR being carried as a 33 bit clock sample using a 90 kilo Hertz clock, but the PCR can be converted to a 27 mega Hertz 42 bit value by multiplying by 300);

PID—Program Identifier which is an identifier that is assigned to each stream within an MPEG-2 transport stream;

PIN—Personal Identification Number;

PMT—Program Map Table which is an MPEG-2 table used to describe the PIDs assigned to a service;

PPV—Pay Per View;

PSI—Program Specific Information;

PVR—Personal Video Recorder which is a storage enabled set-top box;

RASP—Random Access Scrambled Stream Protocol;

RECM—Reference ECM which is placed in a transport stream and including an identifier used to find another ECM which can be used to create a control word;

RSS—Really Simple Syndication;

RTS—Reference Time Stamp which is a 32 bit timecode, running at 27 mega Hertz, that is inserted in to a DSS stream to enable service components such as video and audio, to be synchronized;

SAP—Session Announcement Protocol;

SCID—Service Channel Identification which is an identifier that is assigned to each stream within a DSS transport stream;

SDP—Session Description Protocol;

SI—Service Information;

SIG—SI Generator which is a head-end component that is used to generate data structures for transmission;

STB—Set-top Box;

SSR—Stream Server which is a digital TV control system designed to generate, process and manage DVB SI and PSI information & data streams to support pay and free-to-air TV, the SSR also managing and synchronizing the configuration of transmission & conditional access equipment;

SVP—Secure Video Processor;

URL—Uniform Resource Locator;

VOD—Video on demand;

XML—Extensible Markup Language; and

XSI—Extended SI which is an over-the-air encoding used for schedule information (extended SI may be required when more sophistical features are necessary for being used in the EPG compared to regular information made available via SI).

The following terms used in the specification and claims are defined as follows:

Content—any block or stream of audio and/or visual data available for retrieval and consumption by the subscriber, for example, but not limited to, a movie or other TV program, music, an application such, as a game, or an interactive application such as a shopping application; and

Event or program—a TV Program.

### BRIEF DESCRIPTION OF THE DRAWINGS

The present invention will be understood and appreciated more fully from the following detailed description, taken in conjunction with the drawings in which:

FIG. 1 is a partly pictorial, partly block diagram view of a peer-to-peer system constructed and operative in accordance with a preferred embodiment of the present invention;

FIG. 2 is a partly pictorial, partly block diagram view showing a preferred IPTV implementation of the system of FIG. 1;

FIG. 3 is a partly pictorial, partly block diagram view showing a preferred method of sharing non-bit-identical content in the system of FIG. 1;

FIG. 4 is a partly pictorial, partly block diagram view showing a preferred method of information flow in a broadcasting and recording phase of the system of FIG. 1;

FIG. 5 is a block diagram view of a personalized ECM server of the system of FIG. 1;

FIG. 6 is a partly pictorial, partly block diagram view showing a preferred method of information flow in a pre-transfer of the system of FIG. 1;

FIG. 7 is a flow chart showing steps in a content transfer phase of the system of FIG. 1;

FIG. 8 is a flow chart showing steps in a post-transfer phase of the system of FIG. 1;

FIG. 9 is a block diagram view showing a requesting peer in the system of FIG. 1 acting as a serving peer for a newly received chunk;

FIG. 10 is a partly pictorial, partly block diagram view of a plurality of super-nodes of the system of FIG. 1;

FIG. 11 is a partly pictorial, partly block diagram view showing use of super-nodes in the system of FIG. 1;

FIG. 12 is a partly pictorial, partly block diagram view of a peer of the system of FIG. 1 allocating bandwidth;

FIG. 13 is a block diagram view showing a preferred method of content search in the system of FIG. 1;

FIG. 14 is a block diagram view showing a preferred RSS Feed EPG system in the system of FIG. 1;

FIG. 15 is a block diagram view showing a preferred method of controlling persistence of content in the system of FIG. 1;

FIG. 16 is a partly pictorial, partly block diagram view showing a preferred method of delivering live-TV using the system of FIG. 1;

FIG. 17 is a partly pictorial, partly block diagram view showing a preferred method of pushing content using a plurality of virtual serving peers in the system of FIG. 1;

FIG. 18 is a partly pictorial, partly block diagram view of a push server in the system of FIG. 1;

FIG. 19 is an interaction diagram showing recovery of missing segments from the push server of FIG. 18 using a broadband interface;

FIG. 20 is an interaction diagram showing recovery of missing segments using multi-broadcast from the push-server of FIG. 18;

FIG. 21 is a partly pictorial, partly block diagram view of a preferred method of error correction for use with the push-server of FIG. 18;

FIG. 22 is a partly pictorial, partly block diagram view of a preferred interleaving process for use with the push-server of FIG. 18;

FIG. 23 is a partly pictorial, partly block diagram view of most preferred push sub-system for use with the system of FIG. 1;

FIG. 24 is a partly pictorial, partly block diagram view showing correction of a broadcast recording in the system of FIG. 1; and

FIG. 25 is a partly pictorial, partly block diagram view of a peer-to-peer system in an IPTV based deployment constructed and operative in accordance with an alternative-preferred embodiment of the present invention.

### DETAILED DESCRIPTION OF A PREFERRED EMBODIMENT

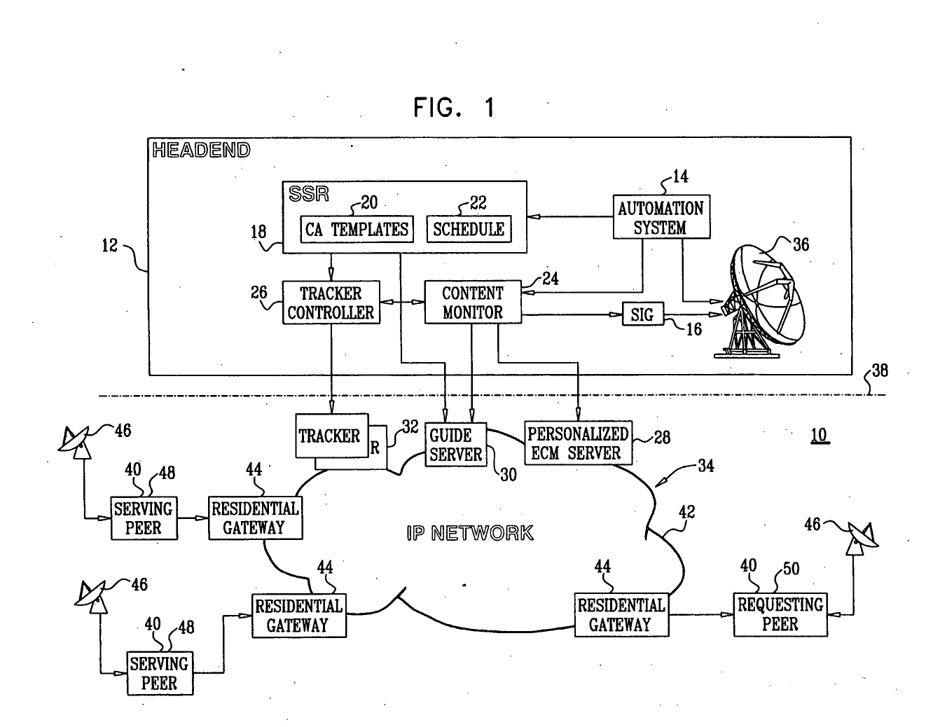

Reference is now made to FIG. 1, which is a partly pictorial, partly block diagram view of a peer-to-peer system 10 constructed and operative in accordance with a preferred embodiment of the present invention.

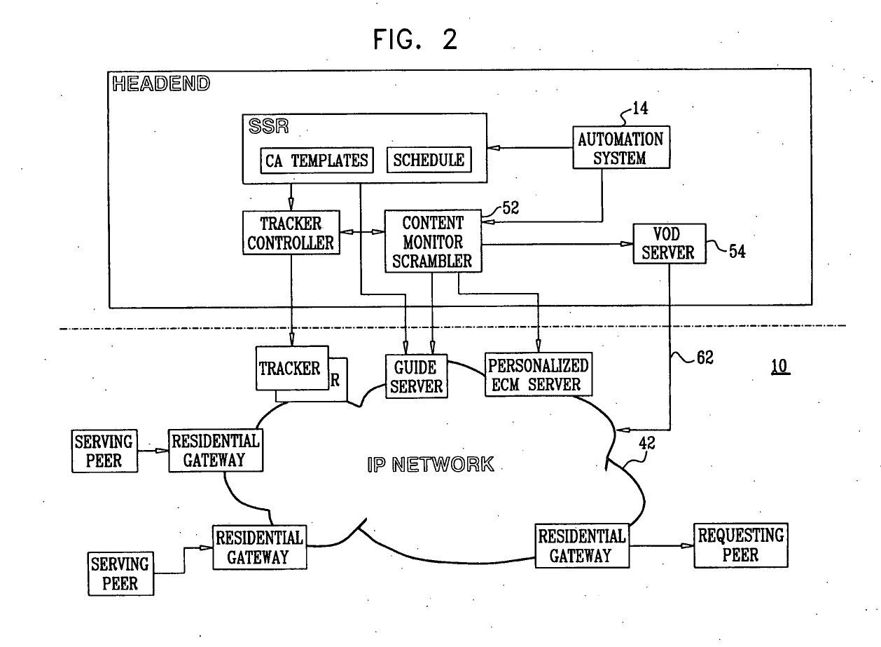

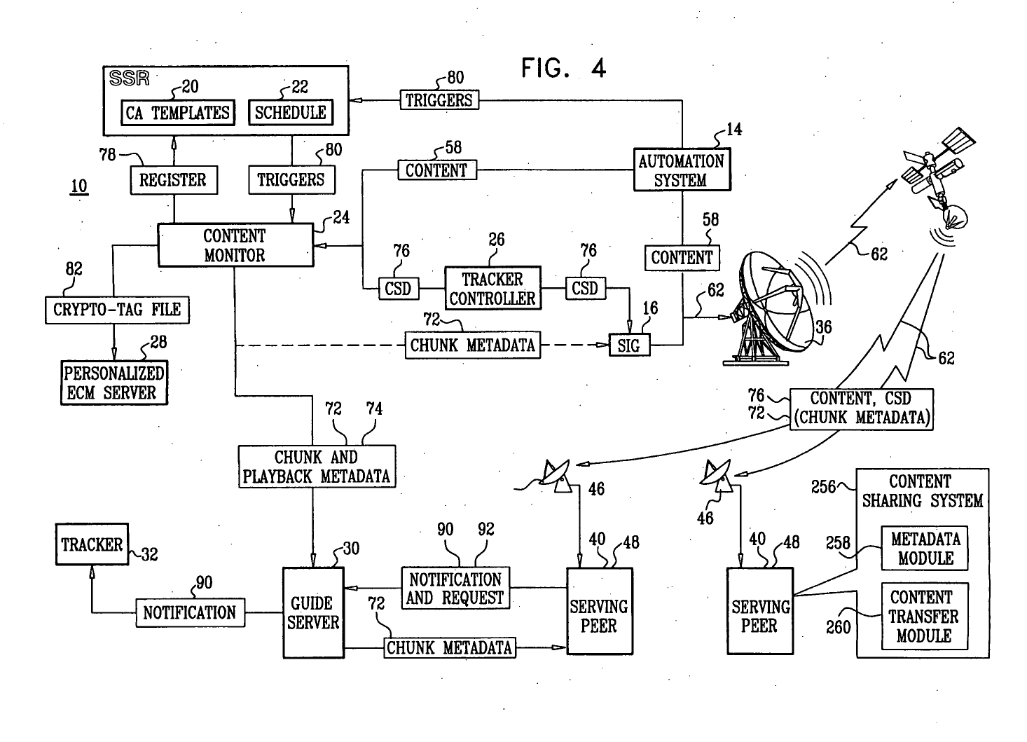

The peer-to-peer system 10 preferably includes a broadcasting Headend 12 including a plurality of Headend components and a plurality of peer-to-peer components. The Headend components preferably include an automation system 14, an SIG 16, a transmitter 36 and an SSR 18 including CA templates 20 and a schedule 22. The transmitter 36 is preferably operative to broadcast content, for example, but not limited to, via satellite, cable, or terrestrial broadcast. An IPTV implementation of the peer-to-peer system 10 is described in more detail with reference to FIG. 2. The Headend components are described in more detail with reference to FIG. 4. The peer-to-peer components preferably include a content monitor 24 and a tracker controller 26.

The peer-to-peer system 10 also preferably includes other peer-to-peer components typically disposed in an access network 34 which is external to the Headend 12. The other peer-to-peer components typically include a personalized ECM server 28, a guide server 30 and a plurality of trackers 32. The content monitor 24 is preferably operationally connected to the tracker controller 26, the automation system 14, the SIG 16, the guide server 30 and the personalized ECM server 28. The tracker controller 26 is preferably operationally connected to the trackers 32 and the SSR 18.

The broadcasting Headend 12 is preferably separated from the access network 34 by a firewall 38.

The peer-to-peer system 10 also includes a plurality of peers 40, preferably located in the homes of subscribers to the peer-to-peer system 10. The peers 40 are typically PVRs or STBs associated with storage devices for example, a disk of a PC in a home network. Each peer 40 is preferably operationally connected via a residential gateway 44 to a communications network, such as, an IP network 42, Asynchronous Transfer Mode (ATM) or Internetwork Packet Exchange (IPX).

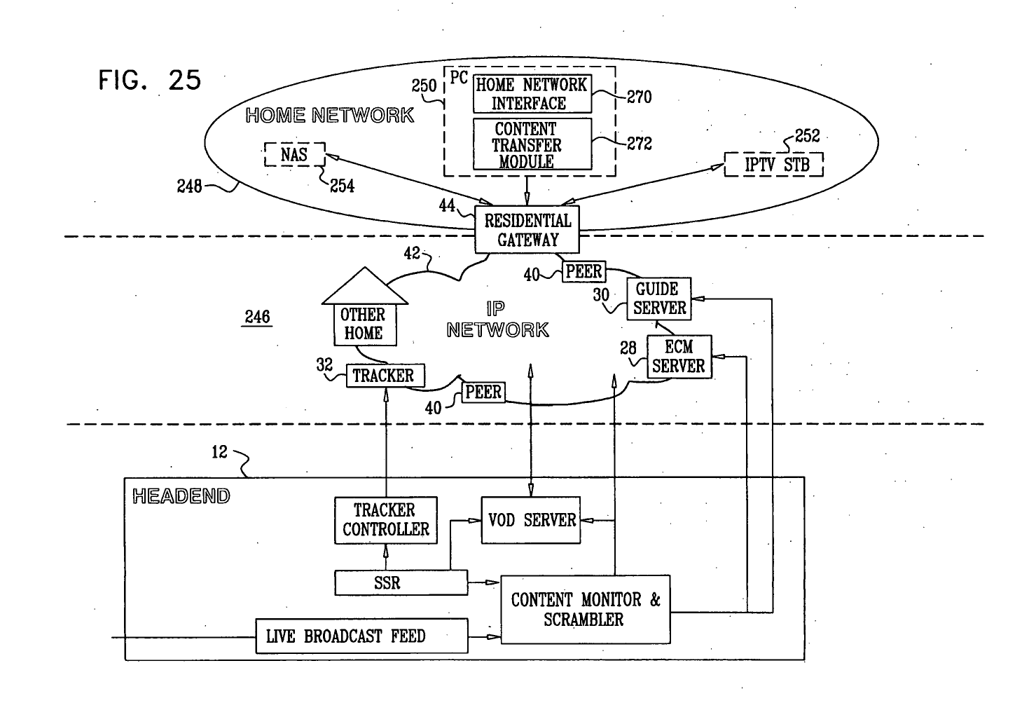

Each of the peers 40 typically has a broadcast receiver 46 to receive content items (not shown) broadcast from the transmitter 36 of the broadcasting Headend 12. The content items may be recorded by the peers 40 and stored in an associated storage arrangement, such as a hard disk of the peers 40 or an NAS device (see FIG. 25). The content items may then be shared between the peers 40 via the IP network 42. It will be appreciated by those ordinarily skilled in the art that one or more of the peers 40 may not have the broadcast receiver 46 and only receive content from other peers 40.

A peer 40 which has content stored therein available for upload to another peer 40 is termed a serving peer 48. A peer 40 which requests content from another peer 40 is termed a requesting peer 50 (only one shown for the sake of clarity). The requesting peer 50 typically makes requests to multiple serving peers 48 in order to acquire the content quicker than a transfer from a single serving peer 48.

It will be appreciated that any peer 40 may be a serving peer 48 or a requesting peer 50 and frequently both at the same time.

One serving peer 48 may upload to multiple requesting peers 50 at the same time and may also act as a requesting peer 50 for another piece of content or other sections of the same piece of content. The sharable content stored in the serving peer 48 was generally acquired from a broadcast tuner (broadcast receiver 46) of the serving peer 48 or an IPTV stream or from another one of the peers 40 in the peer-to-peer system 10.

By way of introduction, in an asymmetric DSL environment, most of the time, the download performance is typically better than the upload performance. By way of example only, in many systems in the year 2006, it is common to have 10 mega bits per second for download and 256 or 512 kilo bits per second for upload. The term “download”, as used in the specification and claims, is defined as the process of receiving data. The term “upload”, as used in the specification and claims, is defined as the process of sending data. For example, when the requesting peer 50 downloads data from one of the serving peers 48, then the serving peer 48 uses the upload capacity of the broadband connection of the serving peer 48 to deliver data to the requesting peer 50.

So when the requesting peer 50 downloads a content item from the serving peers 48, the requesting peer 50 preferably takes benefit of the download speed to request different sections of the content items from a plurality of different serving peer 48 due to the limitation of the upload capacity of each of the serving peers 48.

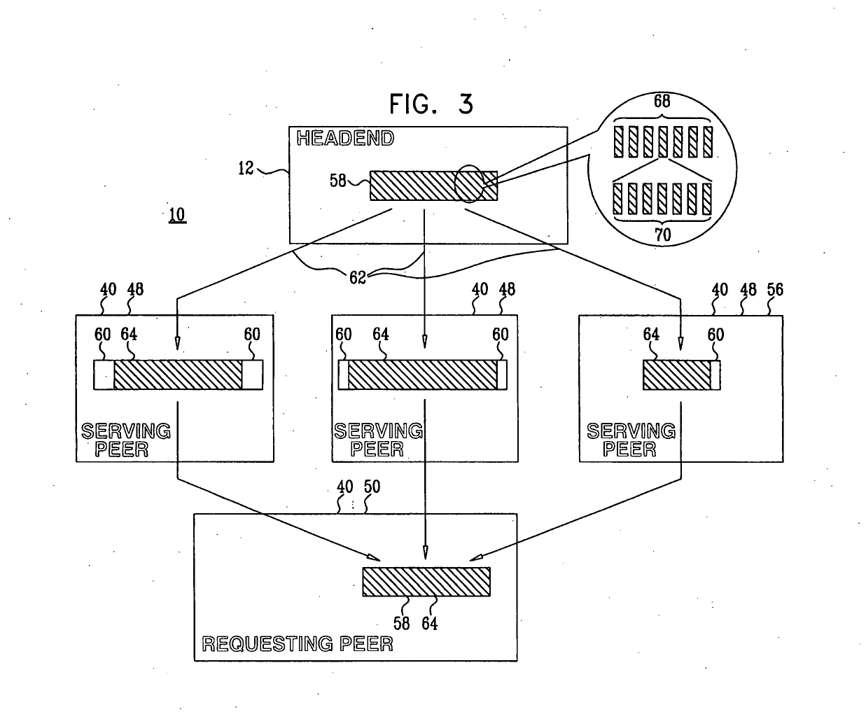

Therefore, each sharable content item is preferably divided into sections called chunks and sub-chunks. Chunks and sub-chunks are described in more detail with reference to FIGS. 3 and 4.

The content monitor 24, amongst other functions, preferably logically divides a broadcast content item into chunks. The content monitor is described in more detail with reference to FIG. 4.

The tracker controller 26 is generally responsible for managing the trackers 32. The tracker controller 26 is described in more detail with reference to FIG. 4.

The guide server 30, amongst other functions, typically includes a list of sharable content as well as metadata used for sharing and playing the content, known as chunk metadata and playback metadata, respectively. The guide server 30 preferably implements sharing rules thereby controlling what content can be shared, when the content can be shared and who can share the content. The guide server 30 is described in more detail with reference to FIGS. 4, 6, 13, 14 and 15.

There is typically one tracker 32 per content item. Each tracker 32, amongst other functions, preferably maintains a list of which peers have a content item, or part thereof. The trackers 32 are described in more detail with reference to FIGS. 4, 6, 7 and 8.

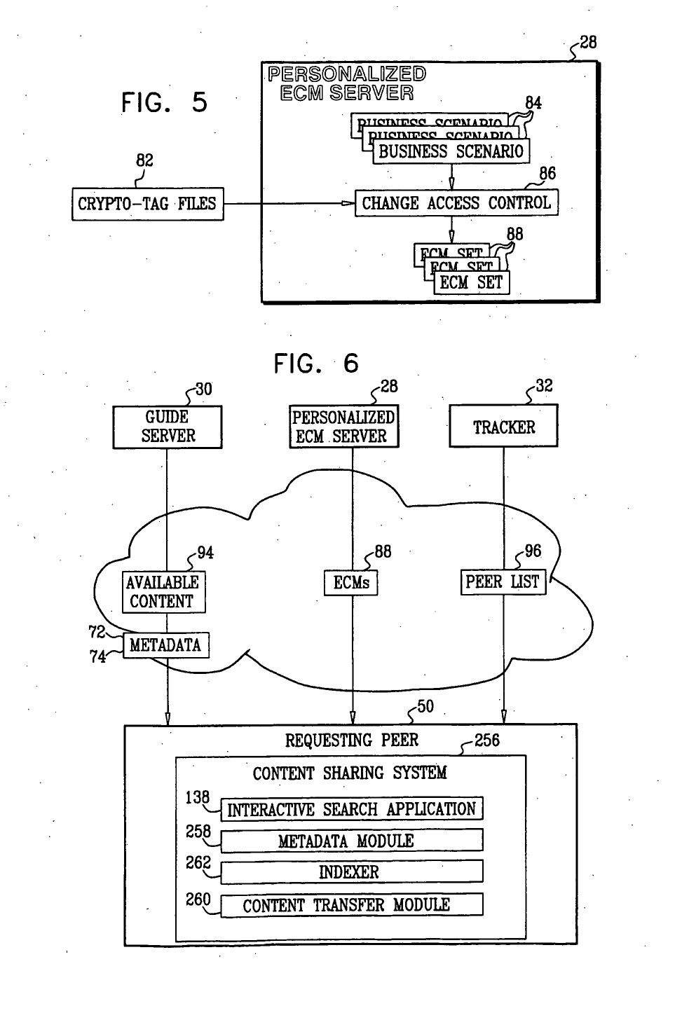

The personalized ECM server 28, amongst other functions, typically provides the ECMs/CWPs for decrypting the content item. The personalized ECM server 28 is described in more detail with reference to FIG. 5.

It will be appreciated by those ordinarily skilled in the art that the personalized ECM server 28, guide server 30 and trackers 32 may also be disposed inside the Headend 12 as long as the peers 40 have access to the personalized ECM server 28, the guide server 30 and the trackers 32.

The peer-to-peer system 10 is described herein with reference to MPEG-2 transport streams. However, it will be appreciated by those ordinarily skilled in the art that the system of the present invention, in preferred embodiments thereof, may be implemented with any suitable transport stream, for example, but not limited to MPEG-2 program streams, DSS transport streams, ASF, and MPEG-4 file format.

The peer-to-peer system 10 is described herein with reference to sharing audio-visual content items. However, it will be appreciated by those ordinarily skilled in the art that the system of the present invention, in preferred embodiments thereof, may be implemented to share any suitable binary format content, for example, but not limited to, interactive applications and personal content.

Reference is now made to FIG. 2, which is a partly pictorial, partly block diagram view showing a preferred IPTV implementation of the peer-to-peer system 10 of FIG. 1. The IPTV implementation is substantially the same as the non-IPTV implementation described with reference to FIG. 1, except for the following differences. The content monitor 24 is typically replaced by a content monitor and scrambler 52. The automation system 14 generally feeds the content to the content monitor 24 which in addition to the other functions, encrypts and encodes the content. The SIG 16 and the transmitter 36 are replaced by a VOD server 54 which is connected to the IP network 42.

It will be appreciated by those ordinarily skilled in the art that the IPTV implementation described with reference to FIG. 2 may be combined with the non-IPTV implementation described with reference to FIG. 1, thereby forming a combined IPTV and satellite/cable/terrestrial broadcast peer-to-peer system.

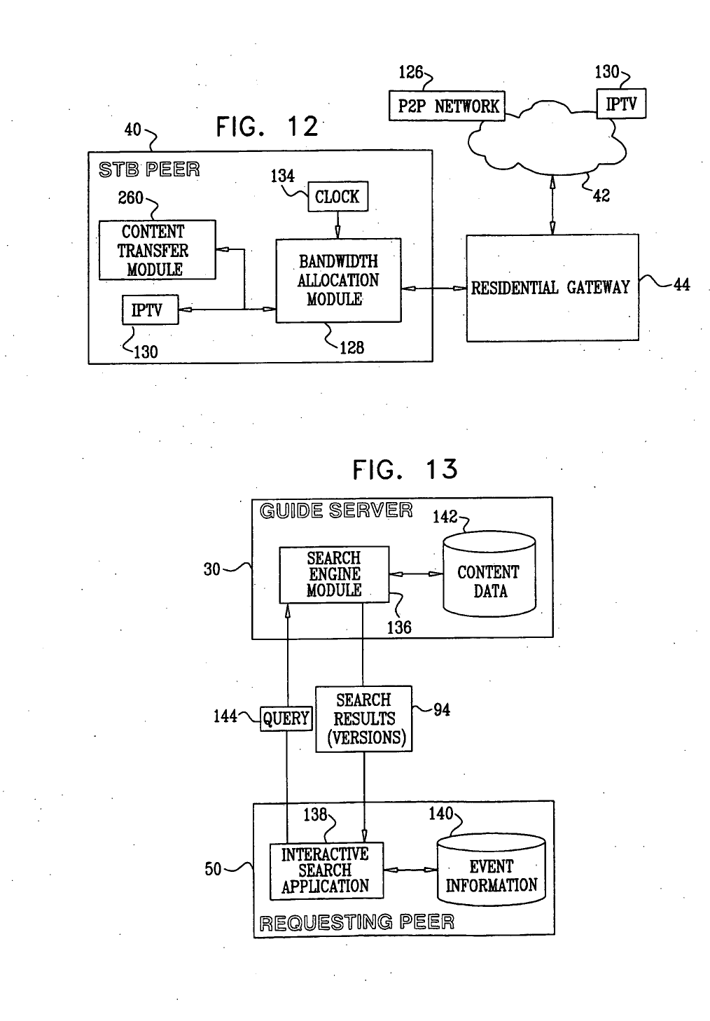

It should be noted that while FIGS. 3-23 are described with reference to the system of FIG. 1, the features described may be implemented with other suitable systems for example, the embodiments of FIG. 2 and/or FIG. 25, or any suitable combination of the embodiments of FIG. 1, FIG. 2 and FIG. 25, by way of example only.

Reference is now made to FIG. 3, which is a partly pictorial, partly block diagram view showing a preferred method of sharing non-bit-identical content in the system 10 of FIG. 1. Reference is also made to FIG. 1.

By way of introduction, due to the broadcast mechanisms used to send a media content item 58 in a broadcast media stream 62 by the broadcasting Headend 12 to the serving peers 48, a recording 64 of the same content item 58 from the broadcast media stream 62, as stored in the storage arrangement of the serving peers 48, may be different between the serving peers 48 (for example, but not limited to, due to lost and/or error packets). Error packets are typically defined as packets with one or more bits in error. It should be noted that cable or satellite or terrestrial or IPTV broadcasting methods can result in error packets. Additionally, the start and end time of recordings may be different between different serving peers 48 so that recording extensions 60 (at the beginning and end of the content item) may be of different lengths, resulting in the different length recordings 64 stored in the storage arrangements of the serving peers 48. Additionally, one of the serving peers 48, a serving peer 56, started the recording 64 after the start of the broadcast of the content item. Additionally, other serving peers 48 (not shown) may have ended recording prior to the end of the broadcast of the content item. Therefore, the different recordings 64 stored in the storage arrangements of the serving peers 48 are different from a bit-to-bit comparison, or in other words the different recording 64 are non-bit identical.

Therefore when the requesting peer 50 wants to transfer a plurality of different sections/chunks 68 of the content item 58 from the serving peers 48, the chunks 68 of the content item 58 cannot generally be referenced with respect to identifiers of the file system of the serving peers 48 for the recordings 64, as the recordings 64 are different (non-bit identical) for each of the serving peers 48. Therefore, the identification of the chunks 68, of the content item 58, preferably needs to be referenced to identifiers in the broadcast media stream 62.

Each chunk 68 is preferably divided into a plurality of parts or sub-chunks 70, described in more detail below.

The logical division of the content item 58 into the chunks 68 and/or sub-chunks 70 typically allows the peer-to-peer system 10 to enable sharing of any chunk 68 and/or sub-chunk 70 stored anywhere in the peer-to-peer system 10 even if the recordings 64 are non-bit identical. Therefore, the requesting peer 50 can generally transfer different chunks 68 (and/or sub-chunks 70) of the content item 58 from many different serving peers 48 at the same time to enable an efficient download of the content item 58, even though the recordings 64 are non-bit identical.

By way of example, an MPEG-2 Transport Stream record may be a very large file, such as a recording of a content item having a duration of 1 hour and 30 minutes at a bit rate of 4 mega bits per second requiring 3 Giga bytes of storage area. The peer-to-peer system 10 allows the content item to be downloaded in an efficient way by downloading several different segments of the content at the same time from different peers 40.

It should be noted that in other P2P content sharing networks, content available for sharing needs to be bit-identical. Therefore, until the content is retrieved via the P2P network by a few new clients, the download rate is limited by the bandwidth of the first source.

However, the peer-to-peer system 10 of FIG. 1, using the chunk content segmentation mechanism, is preferably operative such that non-bit identical recorded broadcast content is immediately sharable by multiple peers 40 thereby typically increasing the download rate of the content. In the peer-to-peer system 10, generally all the peers 40 that have recorded the content (or even only segments of the content) become sources for the recorded content, even though the recordings may not be non-bit identical.

Although the peer-to-peer system 10 is particularly useful for non-bit identical content, the peer-to-peer system 10 may also be used with bit-identical content. For example, some of the serving peers 48 may include recordings recorded from the broadcast media stream 62 broadcast by the broadcasting Headend 12, whereas other serving peers 48 may include recordings recovered from other serving peers 48 via the peer-to-peer system 10. The content item 58 typically originates from the broadcast media stream 62 broadcast by the broadcasting Headend 12 and is then transferred among the peers 40 as required.

The chunks 68 may be divided into the sub-chunks 70 for ease of content transfer, described in more detail below. One chunk 68 is the minimum sized item that a serving peer 48 is generally allowed to offer to serve (even if the serving peer 48 only ends up serving one of the sub-chunks 70 of a particular chunk 68). The protocol used between one of the serving peers 48 and the requesting peer 50 allows a mutual exchange of information about which of the chunks 68 are available on each peer 40. As soon as the requesting peer 50 has completed the download of one of the chunks 68, the requesting peer 50 is generally able to act as a serving peer for the downloaded chunk 68. When the content item 58 is split into the chunks 68, all the peers 40 preferably use the same chunk boundaries in order to share the content item 58. The process of dividing the content into chunks 68 as well as schemes to identify each chunk is described in more detail with reference to FIGS. 1, 2 and 4.

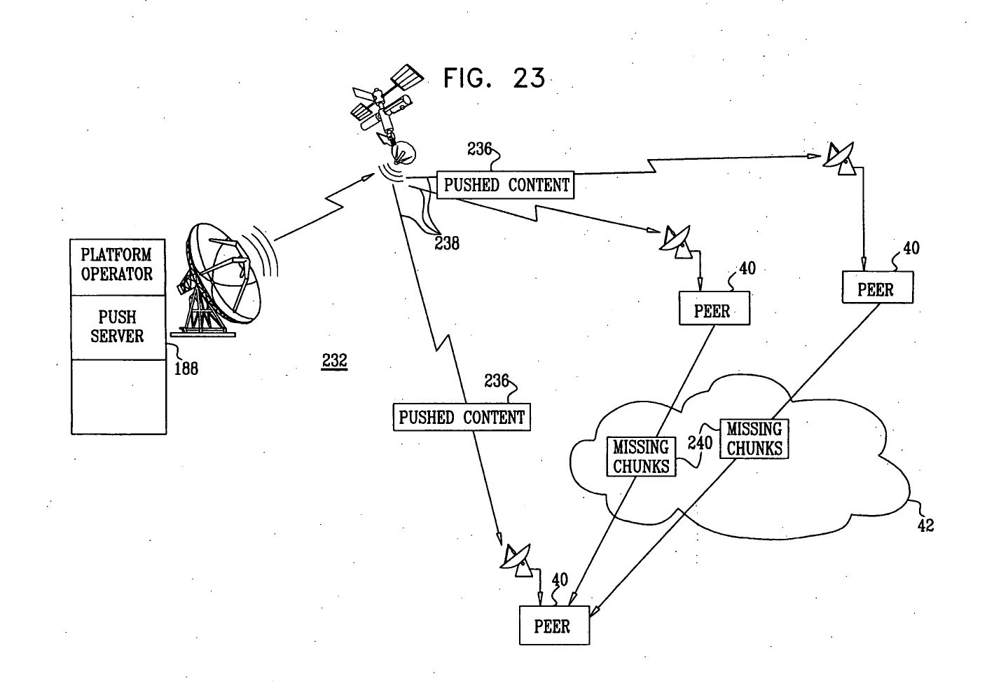

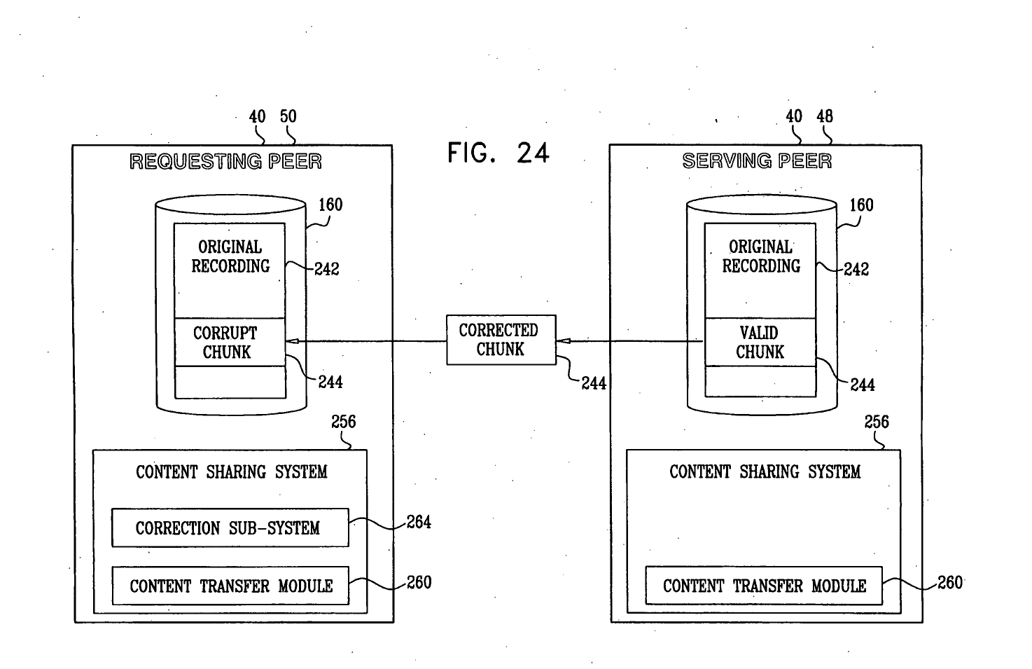

It should be noted that although FIGS. 1-11 describe sharing the whole content item 58, the peer-to-peer system 10 may be used to share/recover a section of an item of content, as described with reference to FIGS. 23-24, by way of example only.

Reference is now made to FIG. 4, which is a partly pictorial, partly block diagram view showing a preferred method of information flow in a broadcasting and recording phase of the system 10 of FIG. 1. Reference is also made to FIGS. 1 and 3.

Chunk metadata and playback metadata, briefly described above with reference to FIG. 1 are now described in more detail.

Each content item 58 preferably has an associated set of chunk metadata 72 and playback metadata 74.

The chunk metadata 72 generally contains all the information that is necessary to enable the serving peers 48 to find the start and end of each of the chunks 68 within the content item 58. The chunk metadata 72 preferably includes the following information: a content identifier; a URL of the tracker 32 for the content item 58; a name of chunk scheme used to sub-divide the content item 58; a size of transport packet (in bytes) in canonical file format; a chunk identifier at the start of the content item 58; a chunk identifier at the end of the content item 58; a chunk boundary table; a discontinuities table; a length of the content item 58 (in transport packets); and a signature of the above information.

Each entry in the chunk boundary table preferably includes the following information: a chunk identifier; and a length of the chunk 68 in transport packets. The chunk identifier is based on an identifier in the broadcast media stream 62 for example, but not limited to, an ECM, a PCR a GOP timecode and/or an RTS timecode. Therefore, the chunk metadata 72 identifies the location of each of the chunks 68 in the content item 58 based on identifiers in the broadcast media stream 62 originally broadcast by the broadcasting Headend 12. It will be appreciated that although the media content may be encrypted or non-encrypted, the identifiers used in the broadcast media stream 62 for identifying the chunks 68 are not encrypted.

The discontinuities table preferably includes the list of discontinuities that occurred during the event. Each entry in the discontinuities table typically includes the following: an identifier of the initial chunk 68; an identifier of the final chunk 68; and a number of transport packets.

The definition of what constitutes a discontinuity is described in more detail below with reference to mapping the system 10 to different schemes, for example, but not limited to, an ECM-Hash scheme, an RECM scheme, a PCR scheme, a GOP_TC scheme, and an RTS scheme.

Before the end of the event, the final chunk identifier value and the content length are not generally known. During the time before the end of the event, the end chunk identifier value in the chunk metadata is typically set to 0xFFFFFFFFFFF and the length field is typically set to the length up to, and including, the end of the last parsed chunk boundary.

The chunk metadata 72 is preferably signed by a party that is trusted by the peers 40. Typically, the party is a certificate authority created by, or trusted by, the platform operator. It is assumed that the chain of certificates required for checking the validity of the signature is preferably delivered by an “out-of-band” channel, such as pre-installation or software download.

The playback metadata 74 generally includes the ancillary information about the content item 58 that is generally required to enable the content item 58 to be consumed. The reason that the playback metadata 74 is necessary is because the broadcast media stream 62 of the content item 58 saved by the serving peers 48 generally does not contain enough information without the playback metadata 74 to allow the content item 58 to be consumed.

The playback metadata 74 typically includes the following information: the content identifier; service data from the start of the event; descriptive metadata; scheduled start and end time; and a signature of the above information.

On a DVB based platform the service data typically includes PSI data such as PAT and PMT. On a DSS based platform the service data typically includes APG data such as boot, channel and program objects.

The playback metadata 74 is typically signed by a party that is trusted by the requesting peers 50. Typically, the party is a certificate authority created by, or trusted by, the platform operator. It is assumed that the chain of certificates required to check the validity of the signature are typically delivered by an “out-of-band” channel, such as, a pre-installation or software download.

When the serving peers 48 are recording the content item 58 from the broadcast media stream 62, the serving peers 48 generally use RASP hardware (not shown) to parse the stream of the content item 58 and build an index to allow random access to the stream. Alternatively, and preferably, the serving peers 48 provide the index, known as index metadata to the requesting peer 50 to avoid the need for the requesting peer 50 to reparse the content item 58. It should be noted that the requesting peer 50 may have to modify the index metadata as entries in the index are generally relative to the beginning of the content on the serving peer 48 and the beginning of the content record 64 on the serving peer 48 may be different from the beginning of the content record 64 on the requesting peer 50. Indexing is described in more detail with reference to FIGS. 6 and 8.

The tracker 32 is typically an Internet connected device that is able to keep track of the serving peers 48 and the requesting peers 50 for the content item 58. The tracker 32 is generally used as a central location service for the requesting peer 50 to find out where in the network the requesting peer 50 can find serving peers 48 that have some, or all, of the requested content item 58. Each sharable content item is typically assigned at least one tracker 32. Therefore, there are typically many trackers 32 in the peer-to-peer system 10.

The tracker 32 preferably maintains a list of the IP addresses and TCP port numbers for each peer 40 that has some, or all, of the content item 58. The tracker 32 generally has limited knowledge of which of the chunks 68 are available on each individual peer 40.

If the sharing rules, which are defined herein below, specify that the content item 58 cannot be shared after a certain date, the tracker 32 typically refuses to serve any of the requesting peers 50 after the date. A similar function is also performed by the guide server 30 (see below). The enforcement of the sharing rules by the tracker 32 is another safeguard to prevent sharing of content which is not allowed by the sharing rules. Once the date has passed, the tracker 32 typically reports back statistical information on the sharing that the tracker 32 has enabled. Once the report back has occurred, the tracker 32 is typically recycled to serve a new content item. Typically, the information is reported back to a system (not shown) controlled by the platform operator as part of the audience measurement system (not shown) of the platform operator.

The collection of all the trackers 32 used for all the content that is available via the peer-to-peer system 10 is called a tracker farm.

The tracker controller 26 is preferably responsible for managing the tracker farm. The tracker controller 26 is generally responsible for making sure there is a free tracker 32 when the content monitor 24 has completed the task of metadata generation. The tracker controller 26 is also typically responsible for managing the load within the tracker farm. The tracker controller 26 is preferably operative to switch one of the trackers 32 from serving one content item to another content item in order to balance the load for popular content. The tracker controller 26 generally provides the guide server 30 with information about what content is available and which of the trackers 32 are assigned to each available content item.

The guide server 30 preferably maintains a list of all the content items allowed to be shared in accordance with the sharing rules. When the chunk metadata 72 and the playback metadata 74 files arrive from the content monitor 24, the list of available sharable content items generally grows by one entry. The guide server 30 typically monitors the expiry date and time of each content item based on the sharing rules and removes entries from the list of available content items when the entries expire.

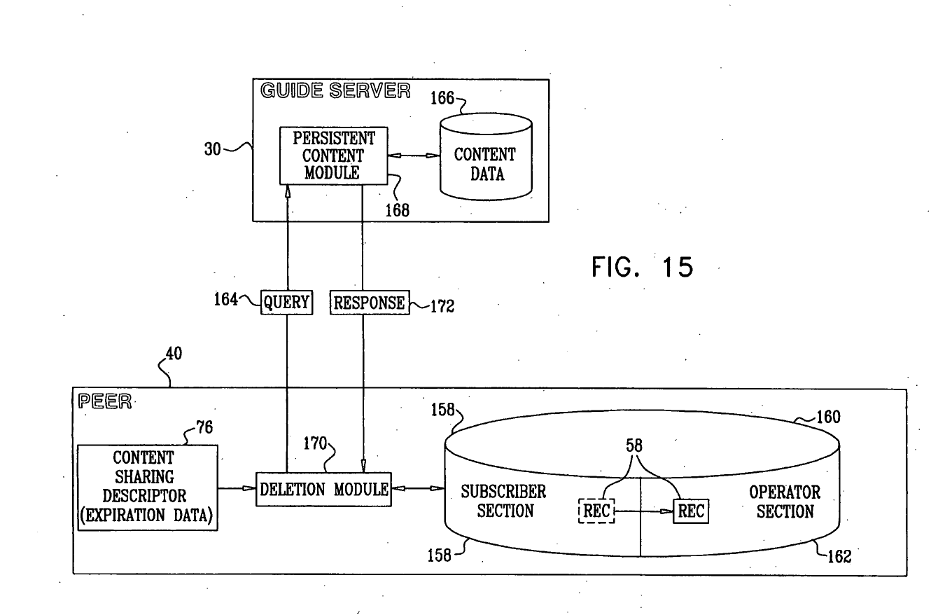

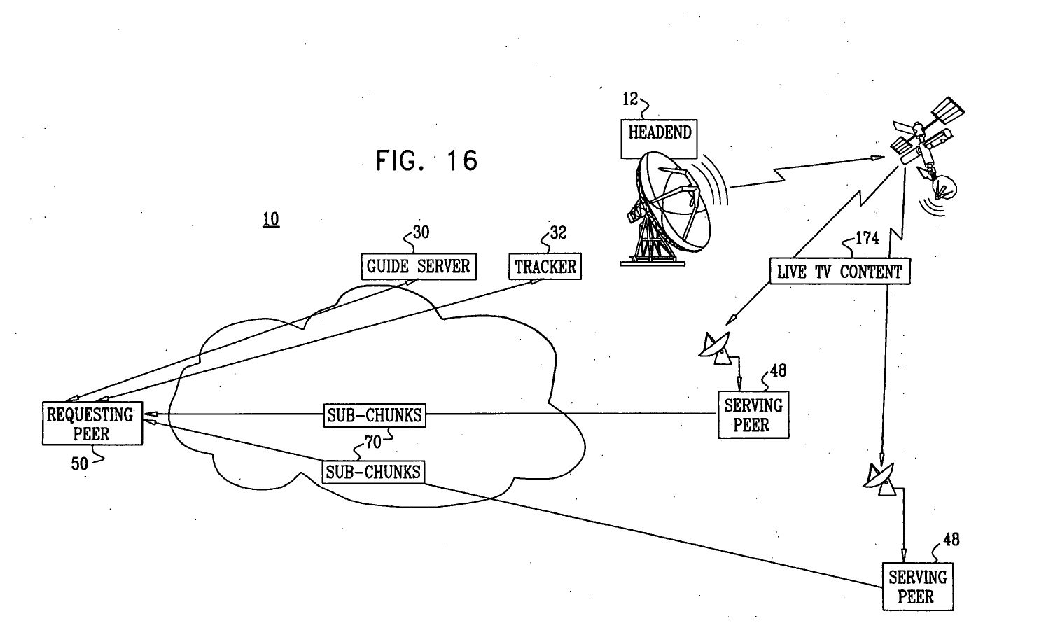

The guide server 30 preferably provides a service to requesting peers 50 to allow the subscriber to find out what content is available from the P2P network, described in more detail with reference to FIGS. 13 and 14. The guide server 30 also typically provides a service to allow the peers 40 to download the chunk metadata 72 and the playback metadata 74 for a particular content item, preferably by serving the chunk metadata 72 and the playback metadata 74 directly from the guide server 30 to the peers 40. In accordance with an alternative preferred embodiment of the present invention, the guide server 30 gives the URL of the chunk metadata 72 and the playback metadata 74 to the peers 40 for retrieval.

Suitable query response protocols for the guide server 30 are known to those ordinarily skilled the art, for example, but not limited to TV Anytime SP006 (ETSI TS-102-822-6). It will be appreciated by those ordinarily skilled in the art that the selected query-response protocol may be different per-platform based on existing infrastructure.

The guide server 30 is preferably protected against TCP/IP based attacks as is known to those skilled in the art.

A metadata database with an associated query and transport protocol may be used as a basis for the guide server 30.

Each of the peers 40 is generally associated with a TCP port and IP address. When a serving/requesting peer 40 makes a request to download the chunk metadata 72, the peer 40 typically provides the port and IP address of the peer 40 to the guide server 30. The guide server 30 generally passes the port and IP address of the peer 40 to the appropriate tracker 32 so that the tracker 32 can update the list of available peers 40 resident in the tracker 32, for example, for use when the requesting peer 50 needs to contact the serving peers 48 during content transfer.

The content identifier, mentioned with respect to the chunk metadata 72 and the playback metadata 74, generally uniquely identifies the content item 58. The content identifier must generally remain unique for the lifetime of the content item 58 for any of the peers 40 in the peer-to-peer system 10.

For content that is riot marked as “delete after date xxx”, the content identifier typically has to be unique indefinitely. The content identifier must generally be able to uniquely identify an individual showing of a content item. When a program is shown repeatedly each showing is preferably assigned a unique content identifier for the showing. It is suggested that another identifier is generated that is generic to all showings of a content item, as the generic identifier will typically increase the number of choices a subscriber has for finding a program.

A content sharing descriptor (CSD) 76 is a piece of information that typically informs the serving peers 48 that the content item 58 is allowed to be shared and includes the URL where the chunk metadata 72 is found. It is assumed that the content sharing descriptor 76 is generally provided along with the event description information (for example, but not limited to, inside XSI/APG/OIG schedule data), transmitted over a broadcast link between the transmitter 36 and the broadcast receivers 46, by way of example only.

The content sharing descriptor 76 typically includes the following data: the content identifier; the URL that points to the location of the chunk metadata 72; the URL that points to the location of the guide server 30, the URL of the chunk metadata 72 and the guide server 30 being the same in accordance with the preferred embodiment of the present invention; a start date and time for the content sharing descriptor; an expiry date for the content sharing descriptor; and “sharing rules author”, “expiry”, “sharing report back” and “sharing report back frequency” fields of the sharing rules.

The URL for the chunk metadata 72 in the content sharing descriptor 76 may refer to a location on the Internet, preferably of the guide server 30, or a location in a broadcast carousel.

Typically the start date and time are set to the scheduled broadcast end time of the content item 58, as the chunk metadata 72 is not generally available before the end of the broadcast. However, when live events are allowed to be shared, the start date and time are typically set to the scheduled start time of the event and the chunk metadata 72 is prepared in such a way as to be available as needed.

It is assumed that the content sharing descriptor 76 is preferably added to the traffic system and passed on to the SIG 16 for encoding in the correct format for the platform, for example, but not limited to, XSI, APG.

The content monitor 24 typically monitors the broadcast media stream 62 of the content item 58, parsing the broadcast media stream 62 in order to provide the chunk metadata 72 and playback metadata 74. In other words, the content monitor 24 preferably logically divides the content item 58 into the chunks 68 thereby creating the chunk metadata 72. Typically, the content monitor 24 parses the broadcast media stream 62 whilst the content item 58 is being broadcast or multicast. It should be noted that the content monitor 24 generally listens to the broadcast media stream 62. The content monitor 24 should preferably not be deployed in such a manner that the failure of the content monitor 24 interrupts the broadcast media stream 62. In some platforms it may be possible to perform the parsing as an offline process.

A content monitor is generally required for each item of content that is allowed to be shared. The content monitor 24 is preferably a fairly lightweight component that allows multiple monitors to be running on a single computer.

The content monitor 24 preferably has a connection to the Automation System 14 so that the content monitor 24 can find out scheduling data 22 for the content item 58. The scheduling data 22 typically includes the scheduled start and stop time of the content item 58, descriptive metadata and optionally sharing rules. If sharing rules are not supplied via the traffic system, the sharing rules may be provided by one of the CA templates 20.

The content monitor 24 typically has a connection to the tracker controller 26 from which the content monitor 24 receives the content sharing descriptor 76. If the content sharing specifies that the chunk metadata 72 is to be included in the broadcast media stream 62, the output of the content monitor 24 process is generally forwarded to the SIG 16 as well as to the guide server 30. The SIG 16 then includes the chunk metadata 72 in the broadcast media stream 62.

For platform operators who use the SSR 18 and have configured the SSR 18 as a client of the automation system 14, the content monitor 24 preferably registers itself as an ESS listener (block 78). The registration typically allows the content monitor 24 to receive triggers 80 that inform the content monitor 24 of the actual start and end of the content item 58 (as opposed to the scheduled start and end of the content item 58). Optionally, when the content monitor 24 is automation trigger enabled (triggered by the automation system 14), the content monitor 24 provides the currently held chunk metadata 72 to the guide server 30 (and possibly the SIG 16) every time a chunk boundary is reached. The provision of the chunk metadata 72 to the guide server 30 preferably allows the guide server 30 (or an object in the broadcast carousel) to provide the chunk metadata 72 whilst the content item 58 is being broadcast, thereby allowing sharing of live television events, by way of example.

In embodiments which do not include automation system triggers, the content monitor 24 generally has to monitor the broadcast media stream 62 for a reasonable period before and after the broadcast of the scheduled event. The reasonable period typically depends on the program, for example, but not limited to, 5 minutes before and after a conventional program and 60 minutes after a live sports event. Some time after the broadcast has finished, for example, but not limited to, a predetermined period once a day (each night), the content monitor 24 is preferably informed of the actual start and end times when the as-run logs are collated from the automation system 14.

Once the broadcast event has finished and the content monitor 24 has been informed of the correct start and end times, the content monitor 24 typically provides the chunk metadata 72 and playback metadata 74 to the guide server 30. The metadata files 72, 74 are separate files from the content item. In accordance with an alternative preferred embodiment of the present invention, the metadata files 72, 74 are transferred to another IP server and the URL of the metadata files 72, 74 is transferred to the guide server. It will be appreciated by those ordinarily skilled in the art that the chunk metadata files 72 and the playback metadata files 74 may be stored on different servers.

The ECMs (not shown) of the broadcast media stream 62 are preferably used by the content monitor 24 to generate a crypto-tag (physical content) file 82 that is generally compliant with the definition in the document ES.IC.SYN.KM010. The crypto-tag file 82 is then passed to the personalized ECM server 28.

Sharing rules are now described below.

The sharing rules are preferably part of the content sharing descriptor 76 which is broadcast to the serving peers 48. The sharing rules are also typically used by the guide server 30 and the trackers 32 to control sharing of content. The trackers 32 typically receive the sharing rules from the content monitor 24 via the tracker controller 26. The guide server 30 generally either receives the sharing rules from the schedule 22 or from the content monitor 24.

A sharing rule is an item of metadata that describes the business rules under which a content item is allowed to be transferred around the peer-to-peer system 10 and shared among the peers 40. Typically, a plurality of sharing rules is defined. A sharing rule is typically attached to each event in the schedule 22 to allow different rules to be applied to each event. It may also be desirable to assign different sharing rules per TV-channel, or per-platform, such that the content items are subject to the per TV-channel or per-platform sharing rules by default, when an event based rule has not been specified.

The typical sharing rules for the content item 58 are shown in Table 1 below.

TABLE 1
sharing rules

| Field | Field Contents |
|---|---|
| Content identifier | Identifier of the content item 58 to which |
| | the rules apply |
| Sharing rules author | URL of the content rights distributor that |
| | defined the sharing rules |
| Expiry | The date and time that the rules become |
| | invalid |
| Sharing report back | URL of the entity that needs to be |
| | contacted when the rules are used to share |
| | the content item 58 |
| Sharing report back | For example, “per share”, “daily”, |
| frequency | “weekly” or “on expiration” |

The sharing rules author field typically conveys information about the entity that holds the rights to allow the content item 58 to be distributed (e.g. “sky.com”, “bbc.co.uk”). In an environment where there is only one content distributor the sharing rules author field is optional.

The expiry date is generally used to enforce dropping a connection between the peers 40 when the expiry is reached, as once a connection between the peers 40 is opened, there is generally nothing stopping the peers 40 keeping the connection open indefinitely.

The sharing report back field is preferably used to enable peer reporting of sharing activity. It is assumed that another system (e.g. an AMS) is typically used to handle reporting of content consumption.

The sharing report back frequency field is typically used to specify when a peer should report sharing activity of the serving peer. When “per share” is used, a serving peer typically reports activity after the serving peer 48 has finished sharing chunks with the requesting peer 50 and the requesting peer 50 connection has been dropped.

Reference is again made to FIG. 1.

The residential gateway 44 is a device that typically connects a home to the IP network 42. A typical example of the residential gateway 44 is a DSL modem/router or a cable modem. In most cases, the residential gateway 44 typically acts as a packet level firewall and provides network address translation.

The residential gateway 44 has the advantage of providing some protection to in-home devices and does not generally require each device in the home to have an Internet routable address. The residential gateway 44 has the disadvantage that a device on the IP network 42 cannot make a connection to a device in the home, which is an issue for me peer-to-peer system 10.

To enable serving peers 48 to be contactable from outside of the home, a route from the IP network 42 needs to be found that traverses the residential gateway 44. The problem of traversing the residential gateway 44 may generally be solved by five different solutions described below.

First, in some situations the platform operator has control over the residential gateway 44 that is supplied to the subscriber. The platform operator can build in fixed routing rules that allow certain Internet traffic to enter the home. For example, ascertain port range may be forwarded to a device with a certain MAC address.

Second, in some situations the platform operator has the ability to remotely configure the residential gateway 44. A standard such as TR69 may be used by the platform operator to reconfigure the residential gateway 44 to allow certain Internet traffic to enter the home.

Third, many of the broadband routers that are available have the option of enabling UPnP based configuration. When UPnP configuration is enabled, any device within the home can request a port from the Internet side of the router to be forwarded to the requesting device.

Fourth, if it is not possible to reconfigure the residential gateway 44 to allow incoming connections, an alternative is to use a proxy that is connected to the IP network 42. Using a proxy has the advantage that it does not require any reconfiguration of the residential gateway 44, but has the disadvantage that all content transfers have to go via the proxy. Another disadvantage is that someone has to supply and maintain the proxies.

Fifth, a UDP based hack may be used. As UDP traffic is connectionless, it is impossible for the residential gateway 44 to be sure when it should pass a UDP packet or block it. Most gateways use an algorithm that assumes that when a UDP packet from a certain port goes out from the home, a packet coming to the same port from the IP network 42 is assumed to be a reply. The “UDP based hack” is a rather crude gateway circumvention technique where a device in the home sends a stream of UDP packets on a range of ports. At the same time a device outside of the home also sends a stream of UDP packets to the residential gateway 44. If the residential gateway 44 incorrectly thinks the incoming UDP packets are replies, it passes the replies to the in-home device. The outcome of the process is that an in-home device and a device outside the home are able to send UDP packets to each other. The devices can now continue to communicate using UDP using the port numbers that have been discovered, or the devices can tunnel TCP on top using the UDP stream. A UDP based hack technique is used by some online computer games and it appears to also be a technique used by the Kontiki P2P system. If a UDP based solution is selected, a method of providing an authenticated channel over a connectionless protocol needs to be used.

The selected method of traversal of the residential gateway 44 typically depends upon the business relationship between the subscriber and the platform operator. In situations where the platform operator is providing a broadband Internet service and the residential gateway, it makes sense to use either the hard coded or remote management solutions. When the subscriber provides the residential gateway or the broadband service is provided by another company, it is suggested to use the UPnP configuration technique.

It is suggested to avoid using the proxy solution wherever possible, due to the requirement for extra proxy devices to be deployed and the reduction in network performance whereby the proxy typically becomes a bottleneck.

Reference is now made to FIG. 5, which is a block diagram view of the personalized ECM server 28 of the system 10 of FIG. 1. Reference is also made to FIGS. 1 and 4. The personalized ECM server 28 generally accepts the crypto-tag file 82 generated by the content monitor 24. The crypto-tag file 82 is then typically available for request by the requesting peers 50 to enable viewing of the downloaded content item 58. Access control to the content item 58 is typically subject to a business scenario when the content item is received from the broadcast media stream 62 broadcast by the broadcasting Headend 12. If the platform operator wants to have different access control than is defined by the original ECMs, the personalized ECM server 28 preferably defines one or more business scenarios 84 to associate with the content item 58 using a change access control module 86 in order to define access control to the content item 58 when the content item 58 is shared among the peers 40 via the IP network 42. Where access to the content item 58 is controlled through a Smart Card for example, a new set of ECMs 88 is typically generated by the personalized ECM server 28 for each business scenario 84. The XTV-server of the NDS Limited Synamedia VOD system is an example of the personalized ECM server 28.

Additionally, there are generally two options for dealing with ECMs, namely “personalized” and “generic”. A “personalized” ECM is tailored to the requesting peer 50 by the personalized ECM server 28 prior to delivery so that the ECMs can only be used. (decoded and decrypted) by the specific requesting peer 50. A “generic” ECM is an ECM that can be used by many peers 40.

An optional step in the requesting peer 50 is to convert generic ECMs in to personalized ECMs for use of a security system (for example, but not limited to, a smart card) within, or connected to, the requesting peer 50. There are many reasons for converting generic ECMs to personalized ECMs, including enhancing security and modifying the expiry date of the ECMs.

Reference is again made to FIG. 1.

It will be appreciated by those ordinarily skilled in the art that as the guide server 30, the personalized ECM server 28, the trackers 32, and the peers 40 are connected via the IP network 42, suitable protection against Internet attacks and exploits need to be established.

Reference is again made to FIG. 3.

Mapping the system to different schemes is now described below.

Each chunk 68 is preferably identified by a suitable identifier. In accordance with the most preferred embodiment of the present invention, the chunk identifier is a 64 bit identifier. An algorithm called a “scheme” is preferably used to create the 64 bit identifier from properties of the audio-visual file. It will be appreciated by those ordinarily skilled in the art that the chunk identifier may be identified by a string of any suitable length.

When the content item 58 is split in to the chunks 68, each chunk 68 is typically specified by: the chunk identifier that references the first packet of the chunk 68; and the chunk length. The translation from the chunk identifier to a position within a recording file is preferably performed using a chunk map. An example is shown in Table 2.

TABLE 2
Example chunk map

| Chunk Identifier | Packet Position |
|---|---|
| 0x6101cb7 | 0x0002d |
| 0x6286b64 | 0x0764a |
| 0x6401e06 | 0x1208e |

The choice of scheme that is used to create chunk identifiers is fairly arbitrary; all that is generally required is that all the peers 40 that are transferring the chunks 68 are all using the same scheme.

An “ECM-Hash” scheme is based on the content of the ECM packets in the MPEG-2 transport broadcast media stream 62. The chunk identifier is 64 bit hash value typically created by passing the contents of the ECM packets through a hash function (see Table 3). The start of any chunk 68 is generally defined as the ECM packet that is different from the previous ECM packet.

TABLE 3
Contents of an identifier using the ECM-Hash scheme

| Field | Size |
|---|---|
| Output of a hash function through | 64 bits |
| which the content of an ECM packet | |
| has been passed | |

Reference is again made to FIGS. 2.

An “RECM” scheme is based on the ECM reference value in the RECM packet. The RECM packet is by way of example part of the NDS Limited Synamedia stream format. A chunk identifier is typically formed by taking the 8 least significant bytes of the ECM reference value (see Table 4). It should be noted that the RECM scheme preferably requires neighboring ECM reference values to be different in the last 8 bits. The condition for the last 8 bits being different is generally satisfied if the ECM reference value has been generated following the algorithm suggested in ES.TS.SYN.SW012 [STA-9309]. The start of any chunk 68 is preferably defined as the packet preceding an RECM packet that is different from the previous RECM packet.

TABLE 4
Contents of an identifier using the RECM scheme

| Field | Size |
|---|---|
| 8 least significant bytes of ECM | 64 bits |
| reference value | |

ECMs having different 8 least significant bytes are implemented such that the last 8 bytes are derived from a value of an incrementing timer whose resolution is in the millisecond range, by way of example. In addition, the timer is generally prevented from resetting over system restarts and/or power-cycles and has sufficient dynamic range to support unique values for at least 5 years. Assuming that the granularity of the timer is smaller than the creation of sequential ECM reference values, neighboring ECM values are typically guaranteed to differ in the last 8 bytes.

In the NDS Synamedia system there are typically two models that can be used for content protection. In one model, content is generally pre-encrypted before being stored on the VOD server 54 and the other model encrypts the content when the content is played from the VOD server 54. In the pre-encryption model, the content monitor and scrambler 52 function is preferably implemented by using the NDS StreamShaper product commercially available from NDS Limited of 1 Heathrow Boulevard, 286 Bath Road, West Drayton, Middlesex UB7 0DQ, UK, which can already be configured to provide an ECM metadata file that provides information about the time and position of the RECMs inserted in to the stream 62. Additionally inputs generally required to determine the chunk metadata 72 (FIG. 4) include the P2P specific information such as the content identifier, the URL of the tracker 32 and the URL of the ECM metadata file. It will be appreciated by those ordinarily skilled in the art that the NDS StreamShaper is listed by way of example only, and that the NDS StreamShaper may be replaced by any suitable content monitor (also known as an IP encapsulator) and scrambler for example, but not limited to, similar products commercially available from Tandberg Television Ltd of Strategic Park, Comines Way, Hedge End, Southampton SO30 4DA, UK and Harmonic Inc. of 549 Baltic Way, Sunnyvale. CA 94089, USA.

Reference is again made to FIGS. 3 and 4.

A “PCR” scheme is based on the PCR value within an MPEG-2 transport stream. The chunk identifier is preferably created by combining the 42 bit PCR value from the transport stream with a discontinuity counter (see Table 5). Whilst the transport stream is being parsed, a record is kept of every PCR discontinuity within the stream. A PCR discontinuity is typically defined as a PCR that is smaller than its preceding PCR, or an increase from the last PCR of more than 5400000.

TABLE 5
Contents of an identifier using the PCR scheme

| Field | Size |
|---|---|
| Reserved (set to zero) | 6 bits |
| Number of discontinuities | 16 bits |
| before the current PCR | |
| PCR | 42 bits |

For encrypted content, the start of any chunk 68 is generally defined as the first transport stream packet on, or after, a control word polarity change. The PCR used for the chunk identifier, is typically the first PCR that occurs in the stream on, or after, the control word polarity change. It is generally recommended that the size of the chunk 68 is bounded by the guidelines of Table 6, by way of example only.

TABLE 6
Recommended chunk sizes

| Recommended | |
|---|---|
| chunk size | Consequence |
| Minimum 10 | For crypto periods of less than 10 seconds, |
| seconds | the chunk 68 is the least multiple of crypto |
| | periods equal to, or larger than, 10 |
| | seconds |
| Maximum 30 | For crypto periods larger than 30 seconds, |
| seconds | the chunks 68 are split in to parts that are |
| | 30 seconds or less. |

For unencrypted content, the start of the first chunk 68 is generally defined as the first transport stream packet that contains a PCR value. Subsequent starts of chunks 68 are typically defined as the first transport packet that contains a PCR value after a pre-defined size (in time) has been reached for the previous chunk 68.

For the first entry in the discontinuity table, the initial PCR value is typically the same as the PCR at the start of the content item 58. For subsequent table entries, the initial PCR value is generally the first PCR that is discontinuous from the preceding PCR. The final PCR value for the last entry in the PCR discontinuity table is typically the PCR value at the end of the content item 58. For other entries in the table, the final PCR value is typically the last PCR value before the discontinuity.

When there are no PCR discontinuities in the content item 58 the discontinuity table is generally empty. The serving and requesting peers 40 typically infer the single entry that would have been in the discontinuity table by using the chunk identifiers at the start and end of the content from the chunk metadata 72.

The amount of storage required for the description of the content item 58 (for example, but not limited to, the chunk metadata 72, the playback metadata 74, and the crypto-tag file 82) in a PCR scheme, generally depends on many factors, such as, the key period and the richness of the descriptive metadata. However, a reasonable estimate can be calculated by assuming certain parameters, described in more detail below.

The size of the chunk metadata 72 may be estimated assuming: no PCR discontinuities; each chunk requires 42 bits to describe the PCR; and each chunk requires 24 bits to describe chunk length. Therefore, assuming a chunk size of 10 seconds, and a content length of 30 minutes, the size of the chunk boundary table is equal to 1485 bytes. Additionally, assuming a content identifier that fits within 16 bytes, the size of the chunk metadata 72 is shown in Table 7, for a content duration of 30 minutes, 1 hour and 2 hours.

The size of the playback metadata 74 may be estimated assuming descriptive metadata fits within 256 bytes, a content identifier that fits within 16 bytes and PSI data that is 400 bytes long. The results are shown below in Table 7.

The size of the crypto-tag file 82 may be estimated assuming a key period of 5 seconds and an ECM of 200 bytes long. The results are shown in Table 7, for a content duration of 30 minutes, 1 hour and 2 hours.

TABLE 7
Size of description of a content item with an ECM key
period of 5 seconds and chunk size of 10 seconds

| | Size of chunk | Size of playback | Size of |
|---|---|---|---|
| Program | metadata | metadata | crypto-tag file |
| Length | (kilo bytes) | (kilo bytes) | (kilo bytes) |
| 30 minutes | 1.5 | 0.7 | 72 |
| 1 hour | 3.0 | 0.7 | 144 |
| 2 hours | 6.0 | 0.7 | 288 |

If we repeat the analysis with a key period of 30 seconds and a chunk size of 30 seconds, the results are shown in Table 8.

TABLE 8
Size of description of content item for ECM key period of
and chunk size of 30 seconds

| | Size of chunk | Size of playback | Size of |
|---|---|---|---|
| Program | metadata | metadata | crypto-tag file |
| Length | (kilo bytes) | (kilo bytes) | (kilo bytes) |
| 30 minutes | 0.5 | 0.7 | 12 |
| 1 hour | 1.0 | 0.7 | 24 |
| 2 hours | 2.0 | 0.7 | 48 |

A “GOP_TC” scheme is based on the GOP timecode found in a DSS stream in an auxiliary data block (AFID type 4). The GOP timecode is in the form hours, minutes, seconds and frames. A timecode discontinuity is typically defined as a timecode that is smaller than the preceding timecode, or an increase from the preceding timecode of more than 60 frames. The typical content of a chunk identifier using the GOP_TC scheme is shown in Table 9.

TABLE 9
Contents of an identifier using the GOP_TC scheme

| Field | Size |
|---|---|
| Reserved (set to zero) | 24 bits |
| Number of discontinuities before | 16 bits |
| the current timecode | |
| Timecode | 24 bits |

An “RTS” scheme is based on the RTS timecode found in a DSS stream in an auxiliary data block (AFID type 0 and type 3). The RTS timecode is similar to the PCR used in MPEG-2 transport streams. It is a 27 MHz-based timecode that is inserted in an unencrypted element of the transport stream. It has a slight drawback compared to a PCR in that it is 32 bits in size, as opposed to the 42 bits used to encode a PCR. Therefore, an RTS time-code wraps much more frequently than a PCR (roughly every 5 minutes). Each wrap of the RTS timecode typically causes a timecode discontinuity. A timecode discontinuity is generally defined as an RTS that is smaller than the preceding RTS, or an increase from the preceding RTS of more than 5400000. The typical content of a chunk identifier according to the RTS scheme is shown in Table 10.

TABLE 10
Content of an identifier using the RTS scheme

| Field | Size |
|---|---|
| Number of discontinuities | 32 bits |
| before the current timecode | |
| RTS Timecode | 32 bits |

A problem can occur with the RTS scheme when start times for the recording of a content item on a collection of devices spans more than the RTS wrap frequency leading to an ambiguity in deciding the start of the content because the same RTS value might be found in different chunks 68.

There are three methods of solving the above ambiguity.

First, for content items longer than 15 minutes, the ambiguity can be solved using a correlation function based on the number of packets in each chunk 68.

Second, by assuming that the clock drift between all recording devices is less than 5 minutes, the metadata associated with the recording allows the serving peers 48 to know when the recording started. By comparing the actual start time to the start time given in the metadata, the serving peers 48 can infer the correct packet of the starting chunk.

Third, if presentation timestamp (PTS) data is being transmitted in the auxiliary data block (AFID type 4), the PTS data can be recorded by the content monitor 24 along with the RTS value for the start of each chunk 68. The combination of the PTS and RTS removes the ambiguity.

Chunk size is now described below.

In most P2P protocols, each chunk of a file has a fixed length, measured in bytes. The peer-to-peer system 10 also typically allows the chunks 68 to be of varying length measured in units of transport packets. The aim is to create the chunks 68, such that the chunks 68 preferably have a similar length in terms of the playback duration.

Assuming that content is being recorded at roughly 4 mega bits per second, various events in the RASP metadata index can be examined to see if the events make useful boundaries for the chunks (see Table 11 below).

TABLE 11
Chunk size comparisons

| | | Estimated chunk |
|---|---|---|
| Event | Frequency | size |
| Key change | Depends on operator | 2.4 mega bytes to |
| | every 5-30 seconds | 14.6 mega bytes |
| Every second | 1 Hertz | 488 kilo bytes |
| Start of GOP/ | 2 Hertz | 244 kilo bytes |
| I-Frame | | |

Analyzing the amount of time it might take to receive one of the chunks 68, gives a feel for how sensible a chunk size is, as shown in Table 12.

TABLE 12
Chunk-size upload times

| | Download time | | |
|---|---|---|---|
| Upload | One (5 sec) | | |
| speed | key period | One second | One GOP |
| (kilo | (2441 kilo | (488.2 kilo | 244.1 kilo |
| bits per | bytes | bytes | bytes |
| second) | piece size) | piece size) | piece size) |
| 8 | 00:40:41 | 00:08:08 | 00:04:04 |
| 16 | 00:20:20 | 00:04:04 | 00:02:02 |
| 32 | 00:10:10 | 00:02:02 | 00:01:01 |
| 52 | 00:06:16 | 00:01:15 | 00:00:38 |
| 64 | 00:05:05 | 00:01:01 | 00:00:31 |
| 128 | 00:02:33 | 00:00:31 | 00:00:15 |
| 256 | 00:01:16 | 00:00:15 | 00:00:08 |

There is another trade-off to be considered with chunk size, namely the amount of memory required in the tracker 32. Smaller chunks generally require more memory in the tracker 32 and more network bandwidth being consumed informing the peers 40 about chunk boundaries.

To solve the two contradictory requirements of upload time and memory required, it is preferable to use reasonably large chunks 68 (to reduce tracker load) and to split the chunks 68 in to smaller units of the sub-chunks 70 for actual content transfer.

So for example, for encrypted content, the chunk size is one key period unless the key period is less than ten seconds. If the key period is less than ten seconds, a chunk is the nearest multiple of the key period that is greater than or equal to ten seconds, as shown in Table 6.

For non-encrypted content, the chunk size is typically 15 seconds, except for the last chunk which is allowed to be smaller than 15 seconds.

For platforms based on MPEG-2 transport streams, a packet is typically 188, 192 or 204 bytes long. For DSS based platforms, a packet is 130 bytes long. Table 13 shows the preferred size of sub-chunks.

TABLE 13
Size of Sub-chunks

| Transport packet size | Sub-chunk size | Sub-chunk size |
|---|---|---|
| (bytes) | (bytes) | (transport packets) |
| 130 | 65000 | 600 |
| 188 | 76704 | 408 |
| 192 | 76800 | 400 |
| 204 | 76704 | 376 |

As there is generally no defined audio-visual stream format on a PVR disk, implementers of PVR play and record drivers have been free to define their own on-disk format. When P2P sharing is enabled between the peers 40, it is generally necessary to define a canonical stream format that can be used by any implementation. For MPEG-2 transport stream platforms, the canonical format is generally defined as: all packets are 188 bytes long; each packet begins with the transport stream synchronization byte; packets include video, audio stream(s), ancillary data (subtitles, interactive application carousel, by way of example), ECMs (optionally may have been corrupted). The following packets are generally not be placed in the canonical file: MPEG-2 PSI tables (PAT, PMT, by way of example only); DVB SI tables (EIT, BAT, by way of example only); and DVB partial transport stream tables (DIT and SIT).

Reference is again made to FIG. 4.

Each of the peers 40 preferably includes a content sharing system 256 for performing peer-to-peer functions. The content sharing system 256 preferably includes a metadata module 258 and a content transfer module 260. The metadata module 258 and the content transfer module 260 are preferably operationally connected. The metadata module 258 is typically operative to request, receive and manage the chunk metadata 72, the playback metadata 74, the index metadata and the ECMs 88. The content transfer module 260 is generally operative to perform content transfer to and/or from other peers 40 including: requesting the chunks 68 from one or more serving peers 48 based on the chunk metadata 72; receiving requests from one or more requesting peers 50 for the chunks 68 based on the chunk metadata 72; transferring the chunks 68 to the requesting peer(s) 50; and receiving the chunks 68 from the serving peer(s) 48.

The content sharing descriptor 76 is preferably broadcast, via the transmitter 36, for each content item for which sharing is to be enabled. The content sharing descriptor 76 may be carried in the scheduling data that is being broadcast, carried in the now-next EPG data or carried in a descriptor in the PSI/APG data broadcast during the broadcast of the content item.

In IPTV implementations, the content sharing descriptor 76 is typically carried within the program description for each content item for which sharing is to be enabled.

When any of the serving peers 48 detect that a sharable content item is being recorded, or has been recorded, the metadata module 258 of the serving peer 48 typically sends a notification 90 to the guide server 30 that the serving peer 48 has the content item 58 (or part thereof) available for sharing.

To avoid millions of the serving peers 48 trying to make the notifications 90 to the guide server 30 at once, the serving peers 48 preferably wait a random period of time before contacting the guide server 30. The random delay typically depends on whether the notification 90 is being sent at the beginning or end of the recording broadcast of the content item 58. Examples of the random delay are shown in Table 14.

TABLE 14
Ranges for random delay before notification

| | Minimum delay | Maximum delay |
|---|---|---|
| Start of | 10 seconds | 5 minutes |
| recording | | |
| End of | 2 minutes | 20 minutes |
| recording | | |

It should be noted that a start of recording notification is only typically sent if the start time of the content sharing descriptor 76 is set to a value that is earlier than the end of the event.

The notification 90 preferably uses the URL of the guide server 30 from the content sharing descriptor 76.

The guide server 30 preferably passes the notification 90 to the tracker 32 of the content item 58.

In order to be able to participate in the P2P sharing of the content item 58, it is generally necessary for the serving peer 48 to make a request 92 for downloading the chunk metadata 72 from the server which holds the chunk metadata 72 (typically the guide server 30). The URL of the chunk metadata 72 is typically included in the content sharing descriptor 76. To reduce the number of transactions across the network, the request 92 for the chunk metadata 72 preferably also includes information about the serving peer 48 making the request 92. In both cases, the notification 90 to the guide server 30 and the request 92 for the chunk metadata 72, generally include the external (Internet visible) IP address of the serving peer 48 and the external port that is bound to the peer-to-peer system 10. Additionally, the request 92 and notification 90 are preferably delayed until the current date and time is equal to or greater than the start date and time of the content sharing descriptor 76.

The request 92 typically at least includes the following fields shown in Table 15.

TABLE 15
Fields in the request 92

| Field | Description |
|---|---|
| content | Content identifier |
| peer | External IP address of the |
| | requesting serving peer 48 |
| port | External port that is bound to the |
| | P2P system |

When the server which holds the chunk metadata 72 is an HTTP server, it is more preferable to implement the request 92 using an HTTP POST request, rather than an HTTP GET request. The reason for the above recommendation is that there are many instances where an arbitrary URL character limit may be imposed that could break an HTTP GET request.

If the external IP address of the serving peer 48 is detected by the serving peer 48 as having being changed (for example, the DHCP lease for the external IP address of the residential gateway 44 has expired), since sending the request 92, the serving peer 48 preferably sends another announcement giving both the old and new external port and IP address of the serving peer 48.

Reference is now made to FIG. 6, which is a partly pictorial, partly block diagram view showing a preferred method of information flow in a pre-transfer of the peer-to-peer system 10 of FIG. 1.

The content sharing system 256 of the requesting peer 50 typically includes an interactive search application 138 (described in more detail with reference to FIG. 13) which makes one or more queries to the guide server 30 to find out what content is available.

A mutual authentication is preferably implemented between the guide server 30 and the requesting peer 50. A two way connection may be performed with an authentication of the client for ensuring both parties check authenticity. Such a process also generally ensures the ability of the requesting peer 50 to accept incoming connections from others peers 40 (FIGS. 1 and 4).

The requesting peer 50 then preferably displays a list of available content 94, received from the guide server 30, to the subscriber (not shown) of the requesting peer 50. When the subscriber of the requesting peer 50 selects the content item 58, the metadata module 258 of the requesting peer 50 typically requests that the guide server provides the chunk metadata 72 (FIG. 4) and the playback metadata 74 (FIG. 4) for the content item 58. The request by the metadata module 258 of the requesting peer 50 generally uses the content identifier that was returned as part of the content search with the list of the available content 94.

In accordance with an alternative preferred embodiment of the present invention, the metadata module 258 of the requesting peer 50 makes a request to the guide server 30 for the URL of the server holding the chunk metadata 72 and the playback metadata 74. The request of the metadata module 258 generally uses the content identifier that was returned as part of the content search with the list of the available content 94. The response from the guide server 30 typically includes the URL from which the chunk metadata 72 can be downloaded and the URL from which the playback metadata 74 can be downloaded. The metadata module 258 typically makes a request to retrieve the chunk metadata 72 and playback metadata 74 using the URL(s) provided by the guide server 30. An authentication step is typically performed including checking the authenticity of both the requesting peer 50 and the server of the metadata 72, 74.

The chunk metadata 72 and the playback metadata 74 are preferably transferred over an authenticated channel from the server (typically the guide server 30) for receiving by the requesting peer 50. An authentication step is typically performed including checking integrity and authenticity of the metadata files 72, 74 typically based on the signature of the metadata files 72, 74.

The authentication steps generally help ensure that all the content shared within the peer-to-peer system 10 is allowed by the platform operator.

The metadata module 258 of the requesting peer 50 also preferably makes a request to the personalized ECM server 28 to download the ECMs 88 required for the content item 58. If the ECMs 88 retrieved by the requesting peer have not already been personalized to the requesting peer 50, the requesting peer 50 optionally personalizes the ECMs 88 prior to storage.

Prior to download of the ECMs 88 by the personalized ECM server 28, the personalized ECM server 28 performs an authentication of the requesting peer 50, typically based on verifying a digital signature (not shown) sent by the requesting peer 50 to the personalized ECM server 28 with the request. The digital signature is typically a digital signature of a cryptographic hash of the request. The request typically includes the content ID, as well as other data such as the smartcard ID of the subscriber (if applicable), the CAS ID, the generation time of the request, the IP address of the requesting peer 50, by way of example only.

It will be appreciated by those ordinarily skilled in the art that authentication between the requesting peer 50 and the personalized ECM server 28 may be performed using any suitable authentication method, for example, but not limited to, HTTP authentication.

The content transfer module 260 of the requesting peer 50 generally sends a request to the tracker 32 to retrieve a randomized list of peers 96 that have some, or all, of the content item 58. The tracker 32 is preferably identified by the URL of the tracker 32 included in the chunk metadata 72.

A mutual authentication is optionally performed between the tracker 32 and the content transfer module 260 of the requesting peer 50. However, the mutual authentication may impact the load of the tracker 32 since the tracker 32 is in charge of managing the overall sharing status between requesting peers 50 and the serving peers 48 for a particular content item.

In the request to the tracker 32, the content transfer module 260 of the requesting peer 50 typically specifies the number of serving peers 48 that the requesting peer 50 wants to connect to. It may be necessary for the content transfer module 260 of the requesting peer 50 to make multiple requests to the tracker 32 for the peer list 96, as some serving peers 48 might no longer be available.

Before content can be transferred, it is preferable for the content transfer module 260 of the requesting peer 50 to set aside disk space for the requested content item 58 so that as sections (for example, but not limited to, the sub-chunks 70 (FIG. 3)) of the content item 58 arrive, the sections can be placed in the correct position in the pre-allocated space in the disk (not shown).

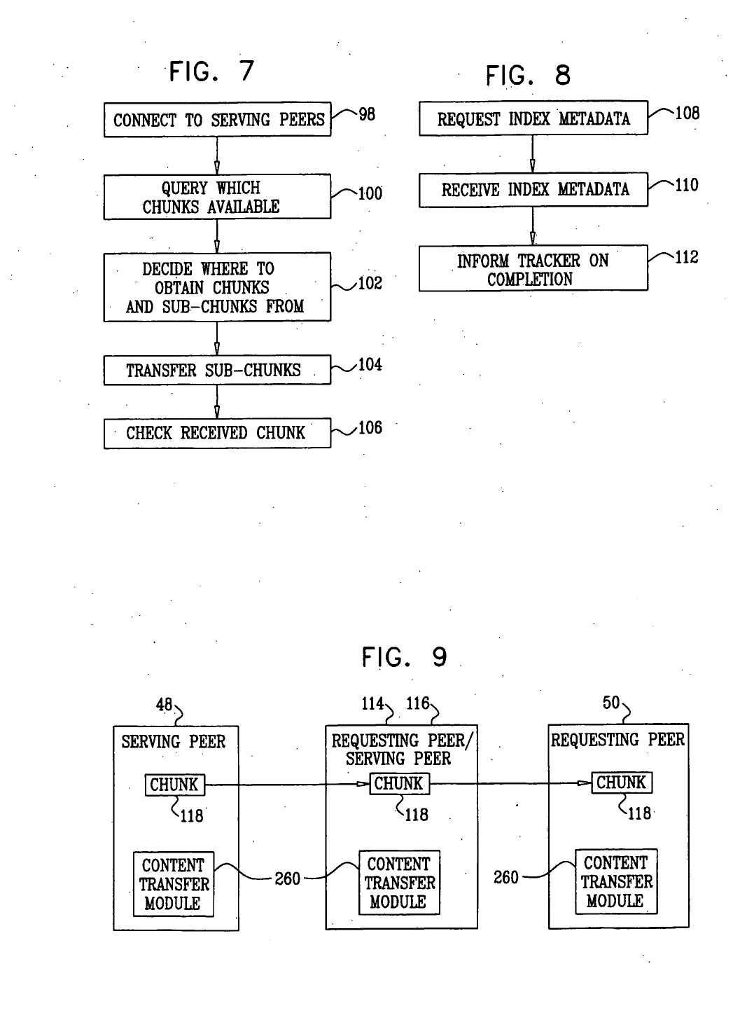

Reference is now made to FIG. 7, which is a flow chart showing steps in a content transfer phase of the peer-to-peer system 10 of FIG. 1. Reference is also made to FIG. 3.

The content transfer phase typically includes the repeated downloading of the chunks 68 of the content item 58 from the various serving peers 48. After the content transfer module 260 (FIG. 6) of the requesting peer 50 receives the randomized list of peers 96 (FIG. 6) that have some, or all, of the content item 58, the content transfer module 260 of the requesting peer 50 preferably connects to the content transfer modules 260 of the serving peers 48 (block 98) to query which of the serving peers 48 have which of the chunks 68 (block 100). It is generally the responsibility of the content transfer module 260 of each serving peer 48 to check if the requested chunks 68 are present and, if present, that the chunks 68 have no errors. The content transfer module 260 of a serving peer 48 preferably declines to serve chunks 68 containing errors (such as transmission drop-outs) by responding that the chunks 68 are not available. The content transfer module 260 of the requesting peer 50 typically then decides from which serving peers 48 to obtain the chunks 68 (block 102). The content transfer module 260 of the requesting peer 50 typically decides to obtain a single chunk 68 from several of the serving peers 48 by dividing the chunk 68 into sub-chunks 70. The chunk metadata 72 (FIG. 4) is preferably used as a guide to divide the chunk 68 into the sub-chunks 70. The chunk 68 and the sub-chunk 70 selection is typically performed using a chunk selection algorithm, (for example, selecting the first n peers, where n is a configurable parameter) to select several of the serving peers 48, indicating that the chunk 68 is present without errors.

Several different chunk selection algorithms have been designed to improve client response or network utilization, as known by those ordinarily skilled in the art, for example, but not limited to the “rarest first” algorithm described in the Article entitled “Incentives Build Robustness in BitTorrent” by Bram Cohen, 22 May 2003 at www.bittorrent.com/bittorrentecon.pdf. However, any suitable chunk selection algorithm may be used for the content transfer phase, for example, but not limited to, latest-chunk-first (reverse chronological order), nearest-chunk-first (by network topology), and free-preview-chunk-first. The exact algorithm to be used for chunk and sub-chunk selection at a given time is preferably selected by the content transfer module 260 of the requesting peer 50, for example, based on the type of application. In a streaming application such as Live or near-live TV, the choice algorithm may be nearest-chunk-first or latest-chunk-first or a combination of the two algorithms. In the case of PPV material that has a free preview window, it is suggested that the default algorithm prioritizes the free preview chunks over the rest of the content using the free-preview-chunk-first algorithm. In other file transfer applications, the rarest-first-algorithm is considered to be most appropriate. Additionally, it is suggested that a default algorithm prioritize the first few minutes of a program in order to allow the subscriber to preview the content before the content is fully downloaded even for non-PPV material.

The content transfer module 260 of the requesting peer 50 then preferably makes multiple requests to the content transfer modules 260 of the selected serving peers 48 for the sub-chunks 70 of the content item 58. Therefore, sub-chunks 70 of one of the chunks 68 are typically requested and received from different serving peers 48. Similarly, different ones of the chunks 68 may be requested and received from different serving peers 48.

Content transfer is typically performed using a secure authenticated channel, preferably using SVP in NSA (native scrambling algorithm) mode (block 104). If second level encryption, such as DES, has been applied to the content on the hard disk of the serving peer 48, the second level encryption is preferably removed by the serving peer 48 and another encryption algorithm (for example, but not limited to, the 128 bit AES algorithm used by SVP) is typically applied instead.

In accordance with an alternative preferred embodiment of the present invention, the content transfer modules 260 of the serving peers 48 are queried about a single chunk 68, typically until several serving peers 48 having the single chunk 68 are found. Sub-chunk selection is typically performed for the single chunk 68. Then, content transfer for the sub-chunks 70 of the single chunk 68 is generally initiated. The content transfer modules 260 of the serving peers 48 are preferably queried about the next chunk 68 while the previous chunk 68 is being transferred, and so on.

Once a complete chunk 68 has been received by the content transfer module 260 of the requesting peer 50, the content transfer module 260 of the requesting peer 50 preferably checks the PCR of the chunk 68 and the length of the chunk 68 with the chunk metadata 72 as well as checking that the chunk 68 includes no padding as a measure against security attacks (block 106). Once a secure complete chunk 68 is received, the content transfer module 260 of the requesting peer 50 then typically becomes eligible to serve the received chunk 68 to the other peers 40. In other words, the requesting peer 50 becomes a serving peer 48 for the received chunk 68.

Reference is now made to FIG. 8, which is a flow chart showing steps in a post-transfer phase of the peer-to-peer system 10 of FIG. 1. Reference is also made to FIGS. 1, 3 and 6. The metadata module 258 of the requesting peer 50 preferably requests the index metadata from one of the serving peers 48 to which the requesting peer 50 is connected (block 108). The index metadata is generally transferred to, and received by, the metadata module 258 of the requesting peer 50 (block 110). An indexer 262 of the requesting peer 50 is preferable operative to build, based on the index metadata, a random access index to the content item 58. The indexer is preferably operationally connected to the metadata module 258.

In accordance with an alternative preferred embodiment of the present invention, once the requesting peer has the entire content item 58, the indexer 262 of the requesting peer 50 scans the content item 58 to build a RASP index for the content item 58. Alternatively, the indexer 262 scans the chunks 68 individually as each chunk 68 is received, thereby allowing the subscriber to watch (or preview) content before the content item 58 has been completely downloaded.

The content transfer module 260 of the requesting peer 50 preferably contacts the tracker 32 to inform the tracker 32 that the entire content item 58 has been received (block 112). Knowledge that the requesting peer 50 has the entire content item 58 may be used in peer selection, described above with reference to the content transfer phase.

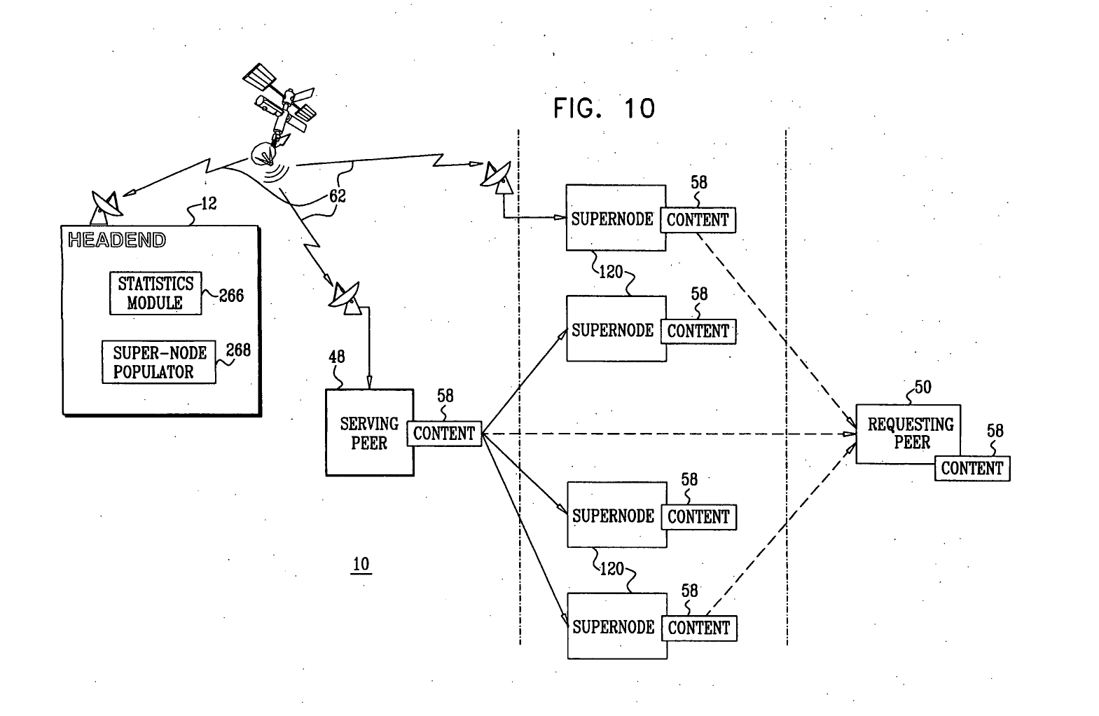

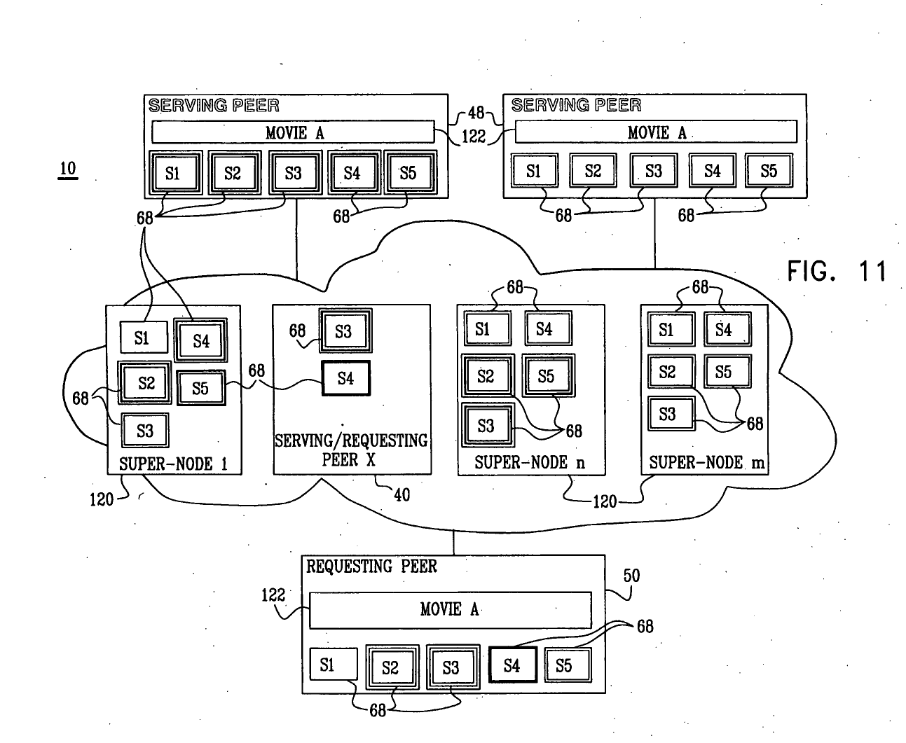

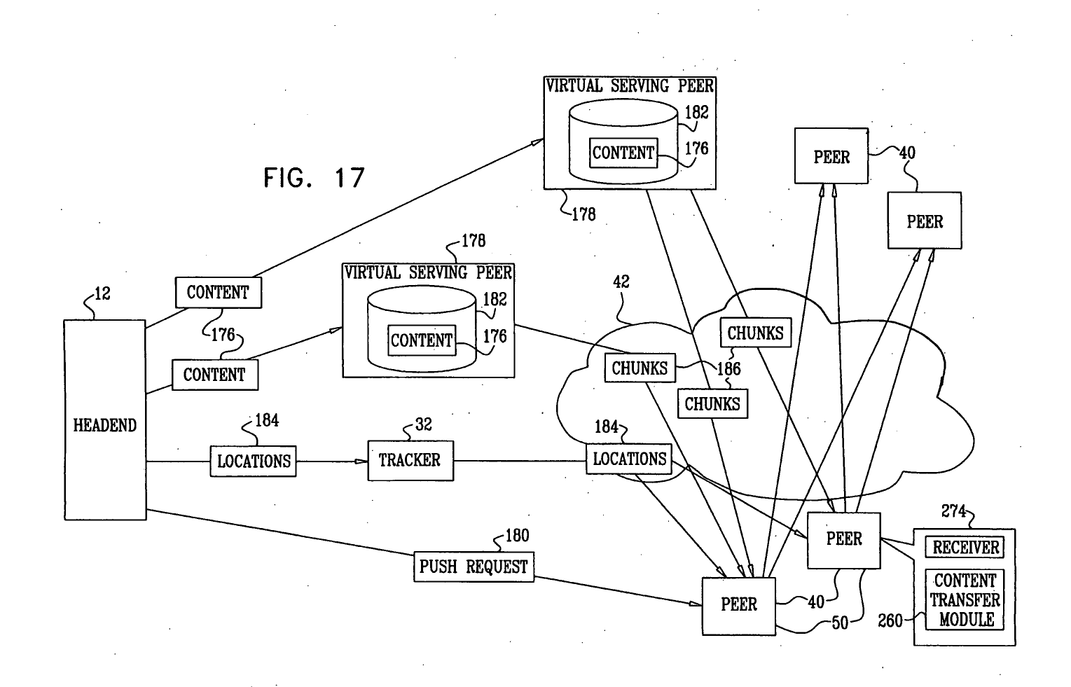

Reference is now made to FIG. 9, which is a block diagram view showing a requesting peer 114 in the peer-to-peer system 10 of FIG. 1 acting as a serving peer 116 for a newly received chunk 118. Once the content item 58 is completely downloaded onto the requesting peer 114, the content item 58 is generally available for download by the other peers 40 (FIG. 1) from the requesting peer 114. Preferably, once any chunk 118 is downloaded onto the requesting peer 114, the downloaded chunk 118 is then available for download by other requesting peers 50 (only one shown for the sake of clarity). Additionally, once the chunk 118 is received by the serving peer 48 in the broadcast media stream 62 (FIG. 3) broadcast by the broadcasting Headend 12 (FIG. 3), the content transfer module 260 of the serving peer 48 may transfer the chunk 118 to the requesting peer 114, for receiving by the content transfer module 260 of the requesting peer 114, even while the content item 58 is still being received by the serving peer 48 from the broadcasting Headend 12. Having each chunk 118 immediately available for download once the chunk 118 has been received is particularly useful for live, or near-live, TV, described in more detail below with reference to FIG. 16. As an efficient P2P network generally relies on the upstream bandwidth of the subscribers, and the more subscribers, the more aggregate bandwidth is available for sharing the files, the peer-to-peer system 10 is preferably designed to leave the serving peers 48 open after recording has been completed so that the others peers 40 may download the recently recorded file from the serving peers 48.

Reference is now made to FIG. 10, which is a partly pictorial, partly block diagram view of a plurality of super-nodes 120 of the peer-to-peer system 10 of FIG. 1. The peer-to-peer system 10 is preferably operative for enhancing sharing of the content item 58 among the peers 40 including the super-nodes 120. The content item 58 was originally broadcast in the broadcast stream 62 by the broadcasting Headend 12 to at least some of the peers 40, 120.

If a sufficient/certain number of the serving peers 48 have not recorded the content item 58 to provide efficient P2P sharing, the platform operator may decide to spread the content item 58 to the super-nodes 120. The decision may be made by a computer system or manually by the platform operator. Each super-node 120 is typically in charge of looking for new content items introduced in the peer-to-peer system 10; retrieving the new content items; and copying the new content items into a reserved part of the hard disk (not shown) of the super-node 120. Thus, when the requesting peer 50 is searching for the content item 58, the content item 58 is preferably already available from multiple sources by way of the super-nodes 120. Alternatively or additionally, the platform operator may decide to effect population of the super-nodes 120 by pushing the content item 58 to the super-nodes 120.

Each super-node 120 is typically, by way of example only: one of the subscriber peers 40 (the subscriber typically explicitly allows the peer 40 to become a super-node 120 and may specify some parameters like bandwidth limits, period of time, by way of example only); and/or a specific system hosted by the platform operator dedicated for sharing recordings (a non-subscriber peer 40).

Each super-node 120 is generally populated by at least one of the following methods: recording content items directly from the broadcast media stream 62; and transferring content items from an already served serving peer 48.

Therefore, the peer-to-peer system 10 preferably includes a statistics module 266 and a super-node populator 268 implemented at the broadcasting Headend 12.

The statistics module 266 is typically operative to determine how many of the peers 40 recorded the content item 58 from the broadcast media stream 62 which was broadcast by the Headend 12.

The super-node populator 268 is generally operative, either automatically based on the count of the statistics module 266, or manually based on the platform operator initiative, to effect population of the super-nodes 120 with the content item 58 after the broadcast of the content item 58 by the Headend 12 if a certain number of the peers 40 have not recorded the content item 58 from the media stream 62. The super-node populator 268 is preferably operative to effect population of the super-nodes by pushing the content item 58 to the super-nodes 120 via another media stream broadcast by the Headend 12 or by initiating a peer-to-peer recovery of the content item 58 by the super-nodes 120 from at least one of the peers 40 via the communications network 42 (FIG. 1).

Reference is now made to FIG. 111, which is a partly pictorial, partly block diagram view showing use of the super-nodes 120 of FIG. 10. The multi-source feature using the super-nodes 120 described with reference to FIG. 10 is preferably implemented using the peer-to-peer system 10 of FIG. 1 whereby the content item 58 is logically divided into the chunks 68 at, or prior to, broadcast. The serving peers 48 have recorded a movie 122 from the broadcast media stream 62 (FIG. 10). The movie 122 includes the chunks 68. The super-nodes 120 have acquired different chunks 68 of the movie 122 from various sources including the serving peers 48 as well as directly from the broadcast media stream. The requesting peer 50 then uses the peer-to-peer system 10 to recover the chunks 68 of the movie 122 from the super-nodes 120 and possibly other peers 40 (only one shown for the sake of clarity).

Reference is again made to FIGS. 1 and 2.

By way of introduction the peers 40 of the peer-to-peer system 10 are preferably equipped with at least: (1) one DVB (DVB-T, DVB-S or DVB-C) tuner (not shown) and an Ethernet front-end (not shown); or an (2) Ethernet front-end only.

Since the recovery of previously transmitted programs is typically a background task, the recovery generally does not disturb the regular STB/PVR behavior of the peers 40. So, the DVB source (DVB Tuner or Ethernet) can typically be used when a background recovery is in progress (Ethernet usage). Therefore, the peers 40 are preferably multi-task enabled. It is important to note that most of the STBs currently deployed with PVR capabilities are able to manage such multi-task situations, for example, but not limited to, a PVR with dual tuners for simultaneous viewing and/or recording of two different programs.

If the dual capability is not possible, then the recovery process may take place when the PVR/STB is “in standby mode”. The term “when the PVR/STB is in standby mode” means that the PVR/STB is not used for viewing TV nor viewing a stored program from the hard disk.

Content sharing is typically under the platform operator control. Therefore, typically no sharing occurs if no sharing rules are defined by the platform operator for an item of content.

Also, even if a content item is authorized for sharing by the platform operator, the subscriber also preferably has the option of preventing previously recorded content being shared with other peers 40, so that if an upload was in progress for a content item, the upload is typically interrupted and the content item cannot be requested by other peers 40 from the subscriber.

If all content stored in the personal storage area is enabled for sharing, by default, according to the sharing rules defined by the platform operator, the subscriber preferably has the ability to override the platform operator setting such that by default all content stored is not sharable. The subscriber can manually select content authorized for sharing. The selection may be performed in a planner section of an EPG used to select, view and manage TV recordings.

The platform operator is typically able to define default rules applied per channel (facility management of sharing rules on a per channel basis).

Optionally, a minimal threshold of serving peers 48 for downloading a recording is established. One reason for the minimum threshold is that a PVR recording is a huge file and therefore a minimal number of seeds are generally required for starting download of content.

PVR behavior may differ according to the deployment solution. For example, all (multiple languages) audio channels may be stored or not on the local PVR. If only the subscriber preferred language is stored, then the proposed tracker server preferably supports multi language tracking capabilities.

Conditional access rule extensions are now described below.

Depending on the platform operator strategy, access to a service for “previously transmitted programs” may be based on a monthly subscription, or per downloaded content. The service may also be offered for free. The Payment strategy may be justified by: the P2P network exists with the help of the platform operator; and network Bandwidth is generally required at the platform operator Head-End 12 to manage the traffic associated with data exchanges.

P2P sharing of broadcast content is typically defined by the platform operator and/or content provider. By default, when no dedicated rule is set, each content item that is authorized for being recorded on the hard disk of the peer 40 may be shared between subscribers subscribed to the recovery service. Such a solution is an extension of existing capability regarding the content lifecycle in PVR devices. The existing conditional access rules optionally define for a particular content: time-shift mode authorized; and recording authorized or not for a particular content item.

The rules are optionally extended to include the following rules: sharing authorized or not authorized for a particular content item; revocation date from which content sharing (with sharing option set to “yes”) becomes invalid; or a delay from the recording date after which content sharing (with sharing option set to “yes”) becomes invalid. The revocation date (or delay) rule is optionally linked to the business rules of the content, for example, but not limited to, the duration of a commercial offer.

Preferably, the business rules used during the original broadcast of a content item are preserved typically by the content monitor 24 recording the access criteria of the original ECMs. The access criteria are typically then passed to the personalized ECM server 28, as described above with reference to FIG. 4. Optionally, the business rules may be modified as described above with reference to FIG. 5.

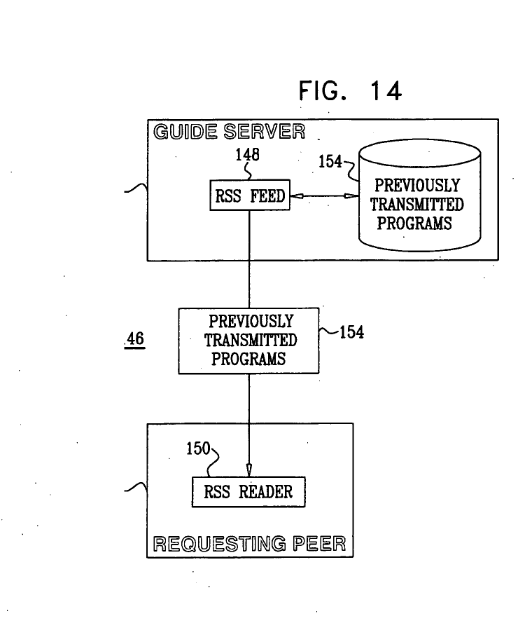

Reference is now made to FIG. 12, which is a partly pictorial, partly block diagram view of one of the peers 40 of the peer-to-peer system 10 of FIG. 1 allocating bandwidth of the residential gateway 44.

In pre/post installation steps of the peer-to-peer system 10, the subscriber can typically at anytime: register as a subscriber of a P2P network service 126 of the peer-to-peer system 10; or cancel registration.

When a subscriber registers, the subscriber can generally opt to accept: download only whereby no content is made available from the hard disk of the subscriber for being shared to the other peers 40; share content only (upload only) where no recovery of previously transmitted content is performed by the PVR of the subscriber; accept to download and upload of previously transmitted content.

As the bandwidth connection may depend on the DSL subscription at home, there is preferably no restriction that all the peers 40 must be on the same network. However, broadband access between the peers 40 and the platform operator Head-End 12 (FIG. 1) is generally required. Different subscribers may then have subscriptions with different Network Access Providers. The subscribers preferably need the ability to access a setting menu to set the resources allocated to the download/upload features.

For upload, the bandwidth used and the maximum number of simultaneous uploads typically needs to be considered. Bandwidth typically ranges from a minimal value (1 kilo bit per second) to a maximum value depending on the connection and on an optional maximum value that may be set by the platform operator (configuration parameters). The maximum number of simultaneous uploads is typically one by default. Alternatively, the maximum number of simultaneous uploads is defined by subscriber input with a maximum value that can be set under the platform operator control (configuration parameters).

Download is typically subject to substantially the same factors considered with respect to upload.

Each peer 40 includes the content transfer module 260 for transferring content between the peers 40 in accordance with the P2P network service 126. The peers 40 preferably includes a bandwidth allocation module 128 to automatically decrease the download bandwidth allocated to the content transfer module 260, for example, if one of the peers 40 receives an IPTV service 130 (TV over DSL channels) via the IP network 42 and the quality of the signal of the IPTV service 130 decreases due to an overload of a communication channel, for example, but not limited to, the residential gateway 44.

Another option typically made available to the subscriber is that the peer 40 is preferably able to configure the timeslots made available on the peer 40 for P2P sharing via the P2P network service 126, for example, but not limited to, between 9 am and 5 pm and between 1 am and 6 am. A clock 134 of the peer 40 is preferably used for giving the current time to the bandwidth allocation module 128. Therefore, the bandwidth allocation module 128 is preferably operative to limit the time availability of the content transfer module 260 to serve content to the other peers 40.

If there are a plurality of peers 40 within one home, the peers 40 are preferably made aware of each other typically using a home network (not shown) in order to prevent the peers 40 trying to request so much content that the bandwidth of the residential gateway 44 is saturated; limit consumption by the peers 40 to a specified quantity of the upload and download capacity of the bandwidth of the residential gateway 44; stop more than one peer 40 trying to download the same content; allow the peers to discover content available on the other peers in the home network; and perform “content mirroring” whereby content is replicated by the peers in the home network using the peer-to-peer system 10 of FIG. 1.

Bandwidth allocation is optionally implemented using Universal plug-and-play (UPnP) services to establish maximum bitrates to the P2P sockets. Alternatively or additionally, bandwidth allocation may be implemented by labeling P2P packets as “background transfer” priority in order for other IP services to take priority.

Reference is now made to FIG. 13, which is a block diagram view-showing a preferred method of content search in the peer-to-peer system 10 of FIG. 1. As explained previously, with reference to FIG. 6, the requesting peer 50 preferably requests the list of the available content 94 from the guide server 30. The guide server 30 is preferably operative to provide the list of available media content 94 to the peers 40 (FIG. 1). The request for the list of the available content 94 is typically based on the content identifier transmitted with the content sharing descriptor 76 (FIG. 4) when the related event is broadcast.

Alternatively, the request for the list of the available content 94 may be based on other criteria as described below.

The requesting peer 50 preferably includes the interactive search application 138 running thereon to search for particular content in a set of event information data 140 stored in the requesting peer 50. The event information data 140 is typically received in the broadcast media stream 62 (FIG. 3), broadcast by the broadcasting Headend 12 (FIG. 3). A title of a content item is preferably retrieved from the event information data 140. The title is then typically sent in a query 144 to the guide server 30. The guide server 30 includes a content database 142 to store data about the available content 94. The guide server 30 also includes a search engine module 136. The search engine module 136 and the content data 142 are preferably operationally connected. The search engine module 136 is preferably operative to receive the search request/query 144 from the requesting peer 50; and search the content database 142 in order to prepare the list of the available content 94. An exact match query is typically made based on the content title.

It is also possible to perform the search within the guide server 30 based on a combination of multiple criteria, for example, but not limited to, other criteria automatically extracted from the event information data 140, for example, but not limited to, director, characters, and genre.

Optionally, the search function may be extended to support subscriber defined search criteria.

Each showing of a program transmitted more than once is preferably assigned with a unique number. Some of the showings may have the same properties, such as, no subtitle and/or same language. Another unique global identifier is preferably generated for grouping the showings in a logical way. The interactive search application 138 is typically responsible for deciding on which basis the search is performed, for example, with an individual unique showing identifier or with the global unique identifier. When the global unique identifier is used, the guide server 30 preferably returns the most popular shared showing for a particular characteristic of the showing or the most frequently broadcast showing. For example, if the characteristic is default language, if a movie was shared 1000 times between the peers 40 with English language default and 2000 times with French language default, then the guide server 30 preferably returns the French language default. Therefore, the search engine module 136 of the guide server 30 is preferably operative to search the content database 142 based on the search request 144 yielding a plurality of results, each of the results being associated with a different default language; and select from the results the content item that is most shared among the peers 40; and send the data about the most shared content item to the requesting peer 50.

An additional request type includes, for example, identifying the top ten downloads in the last n hours.

A catalog of previously transmitted programs based on an EPG is now described.

An EPG service is preferably made available to provide access to the “previously transmitted programs” available in the platform operator domain via a “previously transmitted program” EPG typically including an EPG grid. The current time is managed by the platform operator and is not subscriber configurable. In many digital TV channels, the subscriber generally sees programming information for the “now” and “next” programs typically based on Event Information data. The EPG service for previously transmitted programs typically shows program information prior to the current time.

Editorial Information related to programs listed in the EPG grid may be obtained in several ways (but not limited to): (a) using broadcast metadata (for example, the DVB EIT table) filtering process in real time; (b) using broadcast metadata (for example, the DVB EIT table) with additional private descriptor(s)/private table(s) filtering process in real time; (c) extraction from a cache stored in a storage area (memory, hard disk), the cache being updated at regular intervals by the STB software either by a download from the broadcast source (for example, but not limited to, a Carousel) or by a download from a remote server via a broadband connection; and (d) online request to a remote server on which the information is stored (via the broadband connection).

It should be noted that EIT preparation at the Head-End 12 (FIG. 1) is generally a very straightforward process. For example, the PVRs deployed by the platform operator may download a system cache comprising EIT information (for example, but not limited to, an archive file mounted in a carousel broadcast by a satellite) every night. The STB modules managing the EIT collection and/or preparation of current and future programs are preferably operative to also manage previously transmitted program EIT data collection/preparation.

Only authorized content for being shared is part of the “previously transmitted program” EPG. The “previously transmitted program” EPG typically includes one or more of the following features: regular EPG display (day/hour and channel browsing) distinguishing content that can be recovered from non-recoverable content; alphabetical listing all programs that can be recovered (a program that is already available on the local PVR hard disk is generally not part of the listing); keyword search based (a private table such as the KWT may be used by the subscriber for browsing the list of contents); and multi criteria search (Google-like, by way of example only).

As a consequence, depending on the subscriber selections, it is generally possible to search the EPG for a previously transmitted program broadcast at a particular date (when the subscriber does not know the program name) or to search for a previously transmitted program name based on an event name or a keyword.

The platform operator can set the default depth of the Event Information storage (maximum number of days before the current day, for example, but not limited to, 15 days).

The programs made available to the subscriber are generally restricted to the programs: authorized for being recorded on the PVR hard disk (content protection management rules in a PVR environment); and authorized for being shared between the peers 40, such as previously transmitted programs not marked “No sharing authorized”.

Alternatively or additionally, a dedicated application (not the EPG itself), similar to a VOD catalog, is optionally operative to list previously transmitted programs authorized for sharing, including offering a search facility (by date, day, channel and/or keywords, by way of example only).

Reference is now made to FIG. 14, which is a block diagram view showing a preferred RSS Feed EPG system 146 in the peer-to-peer system 10 of FIG. 1. A catalog of a plurality of previously transmitted programs 154 based on RSS is described below as an alternative or addition to the EPG based catalog described above.

The Guide Server 30 is optionally operative to implement a Program-on-demand Archive TV-like (podArchiveTV-like) concept so that content item information about all sharable previously transmitted programs 154 is typically available on the requesting peer 50 via an RSS feed 148 from the guide server 30. An enclosure asset field (not shown) of the RSS feed 148 is generally the URL that points to the location of the chunk metadata 72 (FIG. 4) and not the content URL.

The requesting peer 50 preferably includes an RSS reader-like application 150. Since the RSS reader 150 preferably uses XML, the requesting peer 50 optionally uses the information received via the RSS feed 148 for personalizing information for display on a TV screen (not shown), for example, but not limited to, “no content stored”, “content recovery in progress”.

The RSS reader 150 is preferably operative to: link to the RSS feed 148; check the RSS feed 148 to see if the feed has new content item information since the last time the RSS feed was checked by the RSS reader 150; retrieve the new content item information; and present the new content item information to the subscriber in an EPG.

No information related to the content sharing descriptor 76 (FIG. 4) is generally required from an STB application managing the request of content from other peers, since all the content sharing descriptor information is generally retrieved online via the enclosure asset field.

Reference is again made to FIG. 1.

Booking “Previously transmitted programs” is now described below. From the list of previously transmitted programs made available in the EPG, the subscriber may select content for downloading to the requesting peer 50 of the subscriber. It is important to note that Conditional Access rules still apply for previously transmitted program content, as described above with reference to FIG. 5. Depending on the subscriber configuration of STB parameters, Parental Control rules may apply to previously transmitted program download. Therefore, a PIN code input may be required to validate a subscriber download request.

Similar to traditional PVR recordings, the subscriber typically has access to a planner section of the EPG for obtaining information about the previously transmitted programs booked for downloading and still pending complete download.

It should be noted that generally all content downloaded from the other peers 40 is preferably not based on the PVR RECORD function. The chunks 68 (FIG. 3) are typically downloaded from several of the serving peers 48 and/or the super-nodes 120 (FIG. 10) and then stored on the PVR hard disk without making use of the PVR RECORD function that is generally in charge of recording a multicast AudioNideo stream.

From the pending download list, the subscriber can typically cancel a program record in progress.

For each program for which a download is in progress, the subscriber preferably has access to some or all of the following information: start date of the download request, percentage of download completion and/or a progress bar-graph display; remaining time; download speed; status (in progress/failure [no more source since×hours]); regular editorial information such as title, description, directors, and actors, by way of example only.

When a download is complete, the information is preferably still available in the download queue view. The downloaded content is generally now part of the local content available for being consumed via the PVR functionality of the requesting peer 50. The downloaded content typically appears in another section of the EPG, such as the planner for listing Personal Recorded Programs, in which the subscriber views content available on the hard disk (not shown) along with programs currently scheduled and/or recorded by the subscriber from the live broadcast, by way of example.

I0t should be noted that when peers 40 recover content via the IP network 42, the resulting file on the storage arrangement of the peers 40 is also called a “recording”.

Reference is now made to FIG. 15, which is a block diagram view showing a preferred method of controlling persistence of content in the peer-to-peer system 10 of FIG. 1.

Given that the time taken for one of the requesting peers 50 (FIG. 1) to retrieve the content item 58 from the peers 40 is generally proportional to the number of peers 40 sharing the content item 58, the peer-to-peer system 10 is preferably operative to control the persistence of the content item 58 on the peer 40 even after “deletion” of the content item 58 by the subscriber. Each peer 40 preferably includes a storage arrangement, such as a disk 160 having a subscriber's section 158 and a platform operator's section 162. It should be noted that the subscriber's section 158 and the platform operator's section 162 are typically logically divided on the disk 160. The subscriber's section 158 is generally operative to store the content item 58.

Therefore, when content that is sharable, for example, but not limited to, the content item 58, is selected for deletion by the subscriber, a deletion module 170 of the peer 40 preferably transfers the content item 58 from a subscriber's section 158 of a disk 160 to a platform operator's section 162 of the disk 160 rather than actually deleting the content item 58 from the disk 160. Therefore, the content item 58 is generally still shareable even after the subscriber has “deleted” the content item 58. Such a feature is typically used to maintain the swarm for content items, for example, but not limited to: popular yet short-lived content such as news or soap operas, where the subscriber is more likely to delete the content from the disk 160 immediately after viewing; and sparsely available content.

Therefore, as described above, content typically appears deleted from the subscriber's section 158 of the disk 160 but in reality the content is mapped to the platform operator's section 162 of the disk 160, assuming space in the platform operator's section 162 is available. When the subscriber selects the content item 158 for deletion, the deletion module 170 preferably sends a query 164 to the guide server 30 as to whether the peer 40 should keep the content item 58 and for how long, in order to remain acting as one of the serving peers 48 for the content item 58. The guide server 30 typically includes a persistent content module 168 operative to: receive the query 164; access a content database 166 to retrieve data relevant to the query 164; formulate a response 172 to the query 164; and send the response 172 back to the peer 40.

Optionally, if the deletion module 10 does not contact the guide server 30 as to whether the peer 40 should keep the content item 58 and for how long, the deletion module 170 preferably keeps the content item 58 in the platform operator's section 162 until the expiry date of the content (in the content sharing descriptor 76) or until the platform operator's section 162 is full. Therefore, on, or after, the expiry date the deletion module 170 typically deletes the content item 58 from the platform operator's section 162. If the disk 160 or the platform operator's section 162 becomes full, the recordings are preferably deleted based on the content expiration date and/or content size. Optionally, an “operator defined algorithm” is implemented on the peer 40 for selecting which content should be deleted first from the hard disk if space is needed, for example, but not limited to, deletion based on the aggregate number of play requests such that less popular content is deleted first.

Reference is now made to FIG. 16, which is a partly pictorial, partly block diagram view showing a preferred method of delivering live-TV using the peer-to-peer system 10 of FIG. 1. The serving peers 48 receive a live TV content 174 item via a broadcast from the broadcasting Headend 12. The requesting peer 50, which may not have a broadcast tuner or a free broadcast tuner (and/or other broadcast receiving equipment), preferably receives the sub-chunks 70 of the live TV content 174 from the serving peers 48 over the IP network 42 using the peer-to-peer system 10 also involving interactions with the guide server 30 and the tracker 32 of the live TV content 174. Therefore, the subscriber of the requesting peer 50 is able to watch “live” or near-live TV using the peer-to-peer system 10.

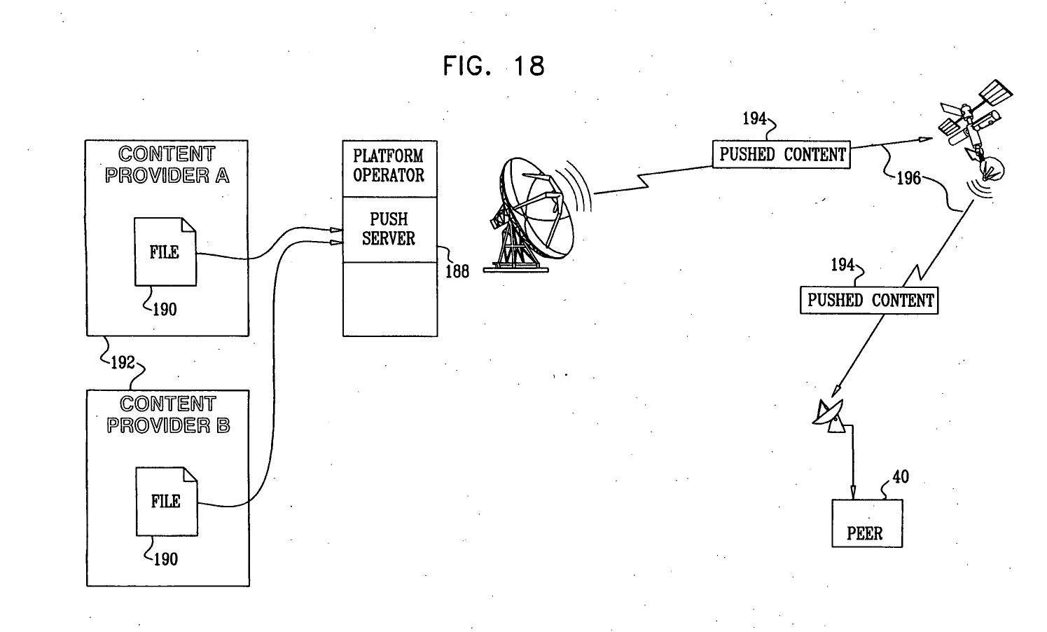

Reference is now made to FIG. 17, which is a partly pictorial, partly block diagram view showing a preferred method of pushing a media content item 176 using a plurality of virtual serving peers 178 in the peer-to-peer system 10 of FIG. 1. In addition to using the peer-to-peer system 10 for obtaining content “on demand”, the peer-to-peer system 10 may be implemented to improve “pushing” content to the peers 40 via the IP network 42.

By way of introduction, the term “pushed content” generally refers to the platform operator sending content to subscriber PVRs for being stored on the storage area of the PVRs. The pushed content is generally sent to all PVRs of the platform operator or a subset of subscribers such as the ones having subscribed to a dedicated service automatically populated by the platform operator. The pushed content is typically stored in the disks of the PVRs with or without authorization of the subscriber, depending on the TV service and/or the subscription level of the subscribers. By way of example only, a subscriber has subscribed to a premium service wherein content is pushed automatically, or the platform operator manages an Ads campaign by populating the hard disks of the PVRs with particular audio-visual sequences wherein no subscriber acceptance is required since it is a platform operator service for managing an interactive area of the TV service.

A preferred method of pushing the content item 176 in the peer-to-peer system 10 is now described below.

Some PVR deployments provide the ability for platform operators to send messages to PVR devices that prompt the PVR devices to record content from a broadcast media stream, the content not having been booked by the subscriber. In a similar fashion, the peer-to-peer system 10 is preferably operative to push a plurality of chunks 186 of the content item 176 by the platform operator, thereby ensuring that a certain percentage of the peers 40 have at least segments of the content item 176. Pushing the chunks 186 may be beneficial for example for niche content that has only been booked for record by a small number of the subscribers or for content that has not been broadcast.

Before a P2P push request 180 is sent by the broadcasting Headend 12, it is generally necessary for the platform operator to place one or more of the virtual serving peers 178 in to the network and seed the tracker 32 of the content item 176 with locations 184 of the virtual serving peers 178. The broadcasting Headend 12 is preferably operative to populate the virtual serving peers 178 with at least part of the content item 176. The virtual serving peers 178 generally store the content item 176 on a hard disk 182 typically using a non P2P method, for example, but not limited to using FTP, IP Multicast with SAP/SDP description for joining the multicast groups. One or more of the virtual serving peers 178 may be a subscriber peer 40. Alternatively one or more of the virtual serving peers 178 may be a non-subscriber peer 40.

The broadcasting Headend 12 may not have to populate the virtual serving peers 178 with the content item 176 if a certain number of the other peers 40 already have the content item 176, for example, but not limited to, via a selective pushed broadcast of the content item 176 to the other peers 40. The broadcasting Headend 12 is preferably operative to send the push request 180 to the peers 40 (the requesting peers 50) in order for the requesting peers 50 to initiate a P2P download of the content item 176 (or segment thereof) via the IP network 42 from the virtual serving peers 178. If a peer 40 already has the content item 176, or the part of the content item 176 described in the push request 180, the push request 180 is typically ignored.

The requesting peers 50 include a receiver 274 to receive the push request 180 from the broadcasting Headend 12. The push request 180 typically joins a queue of pending P2P downloads. When suitable resources are available, the chunks 186 of the content item 176 are generally downloaded by the content transfer modules 260 of the requesting peers 50 over the IP network 42 using the peer-to-peer system 10. The chunks 186 are typically stored in platform operator's section 162 of the disk 160 (FIG. 15) of the requesting peers 50 and the chunks 186 are typically not visible to the subscriber. However, it will be appreciated by those ordinarily skilled in the art that the chunks 186 may be stored in the subscriber's section 158 of the disk 160 (FIG. 15) in which case the subscriber knows about the presence of the chunks 186. As the pushed content is generally not available for viewing by the subscriber there is typically no need for the requesting peers 50 to download the playback metadata 74 (FIG. 4) or build a metadata index. When one of the chunks 186 has been downloaded, the tracker 32 is preferably informed in substantially the same manner described above with reference to FIG. 8.

Therefore, use of the peer-to-peer system 10 generally significantly decreases the broadcast resources required for implementing a pushed content service.

Additionally, the pushed content may be broadcast only once (for example, at a higher rate than the normal play rate) to a selected number of the peers 40 and/or different chunks on different peers 40. Then the peer-to-peer system 10 preferably employs P2P downloads to distribute the whole pushed content item 176 among the peers 40 that need to receive the pushed content item 176.

In addition to a completely unsolicited acquisition of content by the subscribers from the platform operator, the platform operator may consider subscriber preferences and/or recommendation metadata as to what content should be pushed to the peers 40 via the peer-to-peer system 10.

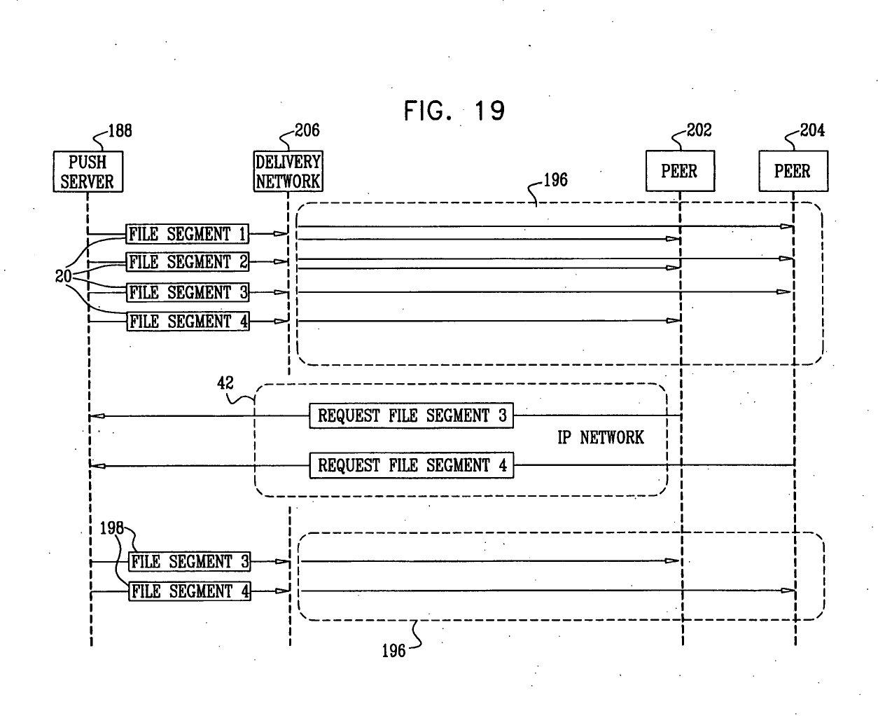

Reference is now made to FIG. 18, which is a partly pictorial, partly block diagram view of a push server 188 in the peer-to-peer system 10 of FIG. 1.

A preferred method to push content is to transfer a plurality of content files 190 from a plurality of content providers 192 to the push server 188 of the platform operator. The push server 188 typically pushes a pushed content item 194 via a broadcast media stream 196 to a selection, or all, of the peers 40 (only one shown for the sake of clarity) in the peer-to-peer system 10.

The delivery mode of the pushed content item 194 is generally under the platform operator's control for example, but not limited to, bandwidth allocation, bit rate, grid of broadcast of the data to be pushed (such as the compressions settings stored in an SSR database).

Due to the STB usage issues (for example, but not limited to, a personal recording is scheduled by the subscriber which in conflict with the pushed content recording), or difficulties encountered on the broadcast interface (weather conditions, bad reception signal, by way of example only), it is generally necessary to set up a strategy to broadcast the pushed data in such a way that all the peers 40 receive the pushed content item 194.

There are several other ways to push the content item 194 from the push server 188 to the peers 40, typically including: broadcasting the content item 194 as the content is made available; or breaking the source of the pushed content item 194 into several segments and then broadcasting each segment for the peers 40 to rebuild the pushed content item 194 from the received segments.

The pushed content item 194 generally needs to be rebroadcast many times as some of the peers 40 may not have recorded the pushed content item 194 or may have missing segments or segments with errors.

Broadcasting the content as it is made available has advantages and disadvantages. An advantage is that the broadcast media stream 196 is typically broadcast using existing equipment. A disadvantage is that if an error occurs during the distribution, the record typically fails and you generally need to wait for another broadcast in order to record the whole content item 194 again. Although, it is generally possible to use an alternative for data broadcast, such as a DSM-CC carousel, the alternative is not efficient as the alternative does not generally allow for a large amount of data, nor broadcast cycle for recovering or getting a part of the carousel, by way of example only.

Breaking the source content into several segments has an advantage that you generally only have to deal with getting the missing segments or bad segments (segments received with errors). Nevertheless, the missing or bad segments typically need to be retrieved.

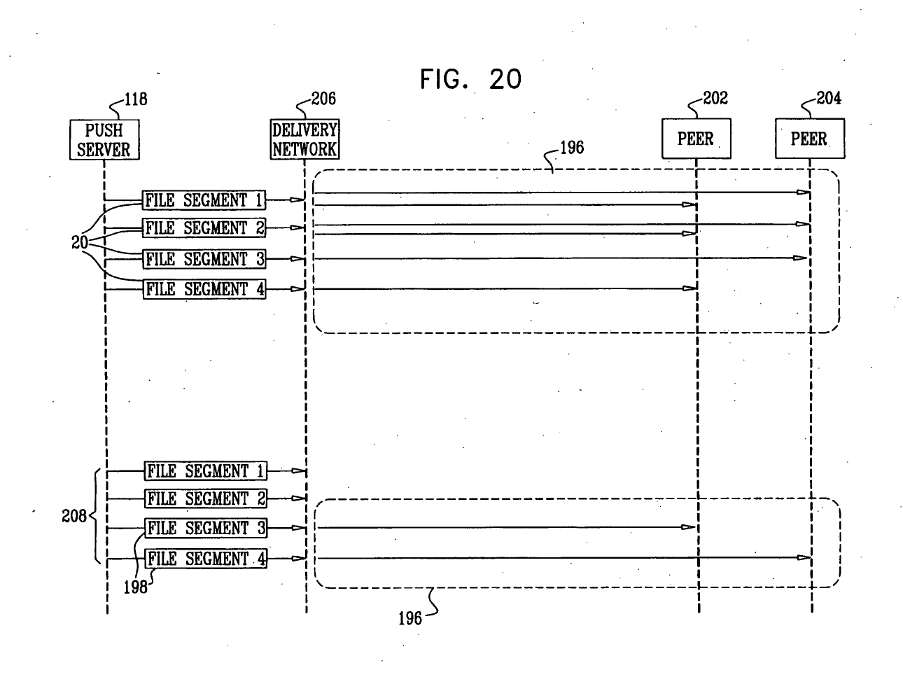

Missing or bad segments may be retrieved, for example, by using a return link for requesting the missing or bad segments (described in more detail with reference to FIG. 19) or waiting for the next broadcast (described in more detail with reference to FIG. 20).

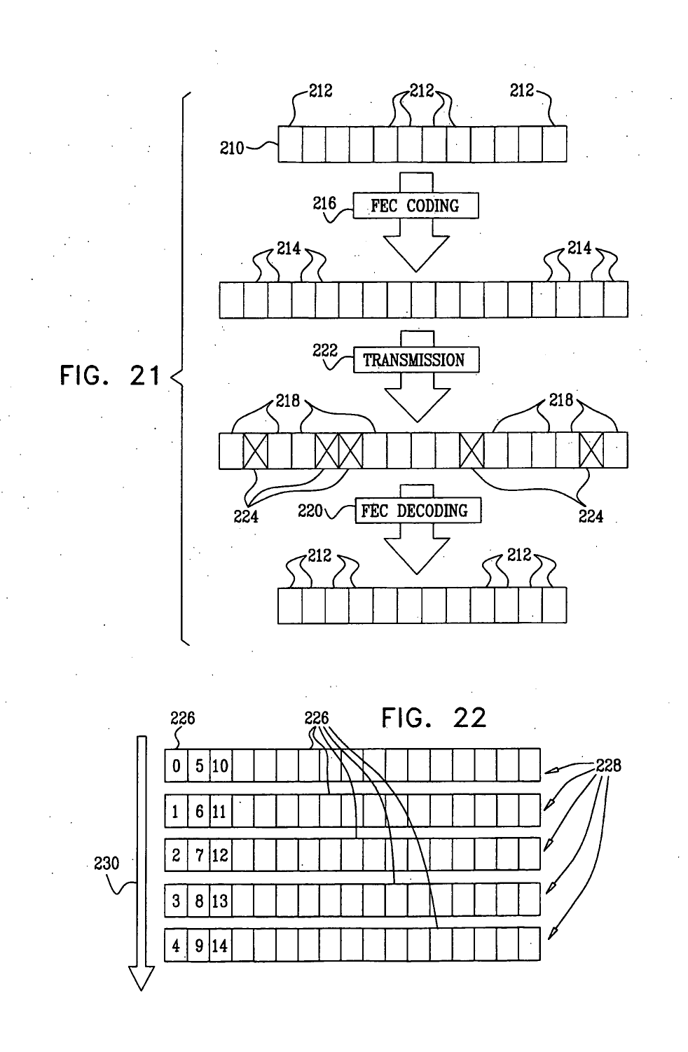

Missing or bad segments may be reduced using techniques known to those ordinarily skilled in the art such as using FEC (described in more detail with reference to FIG. 21) or interlacing (described in more detail with reference to FIG. 22.

It will be appreciated by those ordinarily skilled in the art that the description with reference to FIGS. 21 to 23 referring to missing segments also applies to bad segments.

Reference is now made to FIG. 19, which is an interaction diagram showing recovery of a plurality of missing segments 198 from the push server 188 of FIG. 18 using a broadband interface (not shown) over the IP network 42.

The pushed content item 194 (FIG. 18) is preferably initially delivered by the push server 188 in a plurality of segments 200 via a delivery network 206 in the broadcast media stream 196. A peer 202 did not receive segment 3 and another peer 204 did not receive segment 4. The peers 202, 204 preferably recover the missing segments 198, by request from the push server 188 via the IP network 42. The missing segments 198 are then redelivered to the peers 202, 204 from the push server 188 via the delivery network 206 in the broadcast media stream 196.

Reference is now made to FIG. 20, which is an interaction diagram showing recovery of the missing segments 198 using a multi-broadcast 208 from the push-server 188 of FIG. 18. The missing segments 198 are recovered by the peers 202, 204 from the next multi-broadcast 208 of the pushed content item 194 (FIG. 18) in which all the segments of the pushed content item 194 are rebroadcast via the delivery network 206 in the broadcast media stream 196.

Efficiency may be improved using FEC and interleaving, now described below with reference to FIGS. 21 and 22, respectively.

Reference is now made to FIG. 21, which is a partly pictorial, partly block diagram view of a preferred method of error correction for use with push server 188 of FIG. 18. A content item 210 is a single piece of data from the system point of view. The content item 210 is divided in K packets 212, the packet size having a fixed value of L (size(PACKET_{—}0)=size(PACKET_{—}1)= . . . =size (PACKET_K-2); size(PACKET_K-1)<=L).

From the initial K packets 212, a plurality of N packets 214 are built by a Forward Error Correction (FEC) coding method 216 at the Head-End 12 (FIG. 1).

The packets 214 are transmitted (broadcast) to the peers 40 (FIG. 18) (block 222).

At the receiver side, the requesting peer 40 (FIG. 18) has the ability to recover the initial K packets 212 from a sub set of K packets 218 received from the N packets 214 using an FEC decoding method 220.

Most of the time, the requesting peer 40 has the ability to recover missing packets via the FEC method when a number of lost packets 224 is no greater than N-K packets.

Missing packets which cannot be recovered via the FEC method may be recovered by requesting missing packets described with reference to FIG. 19 or by waiting for a further broadcast window for the same content described with reference to FIG. 20. Waiting for the next broadcast in order to recover missing packets is generally required if the FEC redundancy is 0% (in other words, no FEC).

Reference is now made to FIG. 22, which is a partly pictorial, partly block diagram view of a preferred interleaving process for use with the push server 188 of FIG. 18.

When FEC is used, an alternative exists to increase the push service efficiency by using an interleaving process by sending different packets 226 in a plurality of groups 228. An arrow 230 shows the progression of time. Most of the time, the missing packets are caused by network issues. The interleaving process generally prevents packet loss greater than (N-K) packets.

For example, where K=10, 50% FEC redundancy gives N=15, interleaving is 10, bit rate is 600 kilobits per second, maximum interruption with no impact is given by (N-K) multiplied by interleaving giving 50 packets (packet size being 1500 bytes) which is equal to 1 second.

The systems/methods described with reference to FIGS. 18-22 even with the use of FEC and interleaving, are generally not efficient in terms of the network resource usage for recovering missing or lost packets.

In accordance with a preferred embodiment of the present invention, missing or lost packets may be recovered efficiently as described below.

Reference is now made to FIG. 23, which is a partly pictorial, partly block diagram view of a most preferred push sub-system 232 for use with the peer-to-peer system 10 of FIG. 1. In the push sub-system 232, the push server 188, of the broadcasting Headend 12 (FIG. 1), pushes a content item 236, typically only once, to the peers 40 via a broadcast media stream 238. The content item 236 is preferably divided into segments, namely a plurality of chunks 240 in accordance with the peer-to-peer system 10 of FIG. 1. When the content item 236 is received by the peers 40, each peer 40 typically checks to see which of the chunks 240 are missing. The peers 40 then preferably recover any missing chunks 240 from the other peers 40 via the IP network 42 using the chunk/content recovery system described with reference to FIGS. 1-9. Recovery of missing/bad chunks is described in more detail with reference to FIG. 24.

Using the chunk/content recovery system/method, described with reference to FIGS. 1-9, is generally a much more efficient than the methods described with reference to FIGS. 18-22. However, it should be noted that FEC and interlacing described with reference to FIGS. 21 and 22 can also be used with the push sub-system 232.

By way of example only, a movie is broadcast with a bit rate of 3.5 Megabits per second over a duration of one and a half hours whereas for a pushed broadcast service, the same movie could be broadcast with a bit rate of 14 Mbps for populating PVR hard disks in 22 minutes. By taking benefit of the peer-to-peer system 10, the movie is broadcast only once and then the IP network 42 is used by the peers 40 to recover missing chunks. Therefore, there is generally a significant reduction in the required broadcast resources compared to using multiple broadcasts for populating PVRs with pushed content.

From the PVR point of view, the push sub-system 232 generally ensures that each peer 40 is populated with the pushed content item 236.

From the platform operator point of view, network resources generally required for delivering “pushed content” are significantly decreased with the push sub-system 232 due to the “one shot strategy” compared to solutions using multi broadcast sessions.

Reference is now made to FIG. 24, which is a partly pictorial, partly block diagram view showing correction of a broadcast recording 242 in the peer-to-peer system 10 of FIG. 1. One of the peers 40 recorded the content item 58 (FIG. 4) from the broadcast media stream 62 (FIG. 4) resulting in the broadcast recording 242 of the content item 58 being stored in the disk 160 of the peer 40. The content sharing system 256 of the peer 40 includes a correction sub-system 264 which is operative to identify one or more bad/missing chunks (by way of example a chunk 244) of the content item 58. The correction sub-system 264 is preferably operationally connected to the content transfer module 260. A missing chunk is typically a chunk not recorded by the peer 50 from the broadcast media stream 62 broadcast by the broadcasting Headend 12 (FIG. 3). A bad chunk is typically a chunk received with an error by the peer 40 from the broadcast stream 62 broadcast by the broadcasting Headend 12 (FIG. 3).

The peer 40 then “becomes” the requesting peer 50 and requests the replacement chunk 244 from the serving peer 48 which has a valid version of the chunk 244 using the peer-to-peer system 10 of FIG. 1. The chunk 244 is then transferred from the serving peer 48 to the requesting peer 50, the content transfer module 260 of the requesting peer 50 being operative to receive the replacement valid chunk 244. It should be noted that the chunk 244 may be recovered from several serving peers 48 as sub-chunks of the chunk 244. The recovery process of bad or missing chunks may either be overt or covert to the subscriber. The replacement valid chunk 244 is then preferably added by the correction sub-system 264 to the broadcast recording 242 stored in the disk 160 of the requesting peer 50. There are several reasons why the broadcast recording 242 may have bad or missing chunks including: the peer 40 is missing the beginning of the content item 58 because the peer 40 started recording after the beginning of the content item; the peer 40 is missing the end of the content item 58 because the peer 40 stopped recording before the end of the content item; reception problems were not corrected by the error correcting codes, leading to packets being dropped by the broadcast receiver 46 of the peer 40; and/or reception problems were not corrected by the error correcting codes, leading to packets being flagged with the transport stream error bit set.

The correction sub-system 264 is also generally used to recover the missing chunks 240 of the pushed content item 236 described with reference to FIG. 23 where the missing chunks 240 were not recorded by the peer 40 from the broadcast media stream 238 broadcast by the push server 188 of the broadcasting Headend 12.

Apart from the final reason described above, all the other conditions generally cause the recording on disk to be smaller than the recording should be. Therefore, the requesting peer 50 typically has a problem integrating a downloaded correct version of the chunk 244 into the existing recording especially as very few file systems (or operating systems) support inserting data into the middle of a file.

A solution to the above problem is to allocate sufficient disk space to hold the downloaded chunk 244 plus any extra packets generally required to maintain transport packet sector alignment. The allocation is preferably performed, depending on the PVR implementation, at one or more of the following times: when booking a recording; when recording is in progress and erroneous packets are detected; and after a recording by parsing the recorded data for detecting erroneous packets and then allocating additional storage space. The corrected version of the chunk 244 may be downloaded to the newly allocated space. Once the download is complete the file system tables are typically modified so that when the content item 58 is viewed, the corrected chunk 244 is viewed instead of the chunk 244 recorded from the broadcast receiver.

The above solution does generally have the disadvantage of increasing the fragmentation of the file system, but fragmentation is a problem that the file system has to deal with anyway and the use of fairly large chunk sizes makes fragmentation a fairly minor problem.

Where a subscriber has not recorded a parts of the program (for example, but not limited to, the first half of a program), the peer 40 automatically detects, typically at the end of the recording, that the content item 58 has a missing segment(s) and that the content item 58 is authorized for sharing. The peer 40 then automatically suggests to the subscriber recovery of the missing segment(s) of the recording from one or more peers 40.

When the correction system is used to recover the first section of a program and the subscriber is watching the program live via a review buffer, then the peer 40 assembles the recovered chunks within the review buffer so that rewind is extended prior to the original start of the review buffer. In general, in order to optimize P2P exchanges the order of chunks received by a peer is typically discontinuous with respect to the originating content. In the above case, discontinuous chunks would cause gaps in the review buffer as the missing portion of the program is being recovered. Therefore, to force an ordered acquisition of chunks and maintain a seamless viewing experience, the system 10 preferably prioritizes the download of chunks closest to the original recording start boundary.

Reference is again made to FIG. 3.

The peer-to-peer system 10 is optionally operative to enable the peers 40 to remove the recording extensions 60. For each piece of shareable content (for example, but not limited to, the content item 58), the chunk metadata 72 (FIG. 4) includes the chunk identifiers at the start and end of the content item. The chunk identifiers may then used to remove recording extensions 60 relating to recording before and after a program including intro and outro. Since the provision of the chunk metadata 72 is under platform operator control, the platform operator may chose to enforce part or all of the intro and/or outro on a given recording, for example, but not limited to, to retain advertising, trailers or other program sponsorship content.

Reference is again made to FIG. 1.

The peer-to-peer system 10 may also be used to resolve tuner conflicts of the peers 40. For example, if a subscriber wants to record 2 programs at the same time but only has one available satellite/cable/terrestrial tuner, the peers 40 may be used to record one of the programs using recovery from the other peers 40 via the IP network 42 using the peer-to-peer system 10.

Reference is now made to FIG. 25, which is a partly pictorial, partly block diagram view of a peer-to-peer system 246 in an IPTV based deployment constructed and operative in accordance with an alternative preferred embodiment of the present invention. The peer-to-peer system 246 is substantially the same as the peer-to-peer system 10 described with reference to FIG. 1, except for the differences described below and shown in FIG. 25.

The residential gateway 44 is preferably connected to the IP network 42 which is operationally connected to the peers 40. The residential gateway 44 is preferably connected to a home-network 248. The peers 40 are external to the home-network 248. The home-network 248 typically includes a PC 250 and/or one or more IPTV STBs 252 (only one shown for the sake of clarity) and/or an NAS device 254.

In the peer-to-peer system 246, the PC 250 may be used as an alternative to a PVR device. The PC 250 may be the final rendering device (assuming some sort of suitable secure playback) or the PC 250 may act as a server for the IPTV STBs 252 providing peer-to-peer services in the home network 248. When the PC 250 acts as a server, the PC 250 preferably includes a home network interface 270 and a content transfer module 272. The home network interface 270 is preferably operationally connected to the content transfer module 272. The home network interface 270 is preferably operative to receive a peer-to-peer service command from the IPTV STBs 252 to recover a media content item from among the peers 40. The content transfer module 272 is preferably operative to: recover the content item from among the peers 40; and transfer the content item to a storage device of the PC 250 or the NAS device 254 for storage therein.

A PC based implementation preferably needs a software component to parse the transport stream to enable the peer-to-peer system 246 to map between chunk identifier values and transport packet positions within a file.

When the PC 250 is acting as a server for the IPTV STBs 252 it is generally necessary for the PC 250 to maintain a list of all the content that the PC 250 has downloaded and provide the list to the IPTV STBs 252. It is recommended that the PC 250 also provides a service to the IPTV STBs 252 that allows the IPTV STBs 252 to request the downloading of an item of content, as described above.

If the PC 250 supports download requests from the IPTV STBs 252 and the IPTV STBs 252 use a different query-response protocol to the one used by the guide server 30, it is typically necessary for the PC 250 to provide a protocol translation service. The protocol translation service preferably needs to provide protocol bridging between the IPTV STBs 252 and the guide server 30.

For cost reasons many IPTV deployments use set top boxes that do not include a hard disk. If it is desired to use the peer-to-peer system 246 in such a deployment it is generally necessary to provide a storage component outside of the IPTV STBs 252. The storage component may be the NAS device 254 such as storage of a PC or other computing device in the home network 248.

In an NAS based implementation a P2P agent generally downloads and uploads content stored on the NAS device 254. The P2P agent may reside in any one of the following locations: within the IPTV STB 252; in the residential gateway 44; in the PC 250; or in the NAS 254.

The position of the personalized ECM server 28, the tracker 32 and the guide server 30 are shown within the IP network 42. However, it will be appreciated that the personalized ECM server 28, the tracker 32 and the guide server 30 may be disposed at the Head-end 12 as long as the personalized ECM server 28, the tracker 32 and the guide server 30 are accessible from the IP network 42. In other words, personalized ECM server 28, the tracker 32 and the guide server 30 are not behind the firewall 38 at the Head-end 12.

It is appreciated that software components of the present invention may, if desired, be implemented in ROM (read only memory) form. The software components may, generally, be implemented in hardware, if desired, using conventional techniques.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

1-58. (canceled)

59. A content sharing system, for implementation in a requesting peer, to receive at least a part of a first chunk from a first serving peer and at least part of a second chunk from a second serving pear, the first chunk and the second chunk being part of a content item, the requesting peer being operationally connected to a plurality of peers including the first serving peer and the second serving peer via a communications network, the first serving peer being associated with a storage arrangement in which the first chunk is recorded, the second serving peer being associated with a storage arrangement in which the second chunk is recorded, the content item being media content originally broadcast in a media stream by a Headend to at least some of the plurality of peers, the system comprising:
a metadata module to receive chunk metadata identifying the location of the first chunk and the second chunk based on an identifier in the media stream originally broadcast by the Headend; and
a content transfer module operationally connected to the metadata module, the content transfer module being operative to:
request the at least part of the first chunk from the first serving peer based on the chunk metadata;
request the at least part of the second chunk from the second serving peer based on the chunk metadata;
receive the at least part of the first chunk from the first serving peer; and
receive the at least part of the second chunk from the second serving peer, and wherein:
at least part of the content item is recorded in the storage arrangement of the first serving peer recorded from the media stream broadcast by the Headend;
at least part of the content item is recorded in the storage arrangement of the second serving peer recorded from the media stream broadcast by the Headend;
the recording of the at least part of the content item in the first serving peer is different from the recording of the at least part of the content item in the second serving peer based on a bit-to-bit comparison; and
the identifier is at least one of the following: an entitlement control message, a program clock reference, a group of pictures timecode, and an RTS timecode.

60. A content sharing system, for implementation in a requesting peer, to receive at least a part of a first chunk from a first serving peer, the first chunk being part of a content item, the requesting peer being operationally connected to a plurality of peers including the first serving peer via a communications network, the first serving peer being associated with a storage arrangement in which the first chunk is stored, the content item being media content originally broadcast in a media stream by a Headend to at least some of the plurality of peers, the system comprising:
a metadata module to receive chunk metadata identifying the location of the first chunk based on an identifier in the media stream originally broadcast by the Headend; and
a content transfer module operationally connected to the metadata module, the content transfer module being operative to:
request the at least part of the first chunk from the first serving peer based on the chunk metadata; and
receive the at least part of the first chunk from the first serving peer.

61. The system according to claim 60, wherein the peers include a second serving peer, the second serving peer being associated with a storage arrangement in which the first chunk is stored, the content transfer module being operative to:
request another part of the first chunk from the second serving peer based on the chunk metadata; and
receive the other part of the first chunk from the second serving peer.

62. The system according to claim 60, wherein the peers include a second serving peer, the second serving peer having a storage arrangement in which a second chunk of the content item is stored, the metadata module being operative to receive chunk metadata identifying the location of the second chunk based on the identifier in the media stream originally broadcast by the Headend, the content transfer module being operative to:
request at least part of the second chunk from the second serving peer based on the chunk metadata; and
receive the at least part of the second chunk from the second serving peer.

63. The system according to claim 60, wherein:
at least part of the content item is included in a recording in the storage arrangement of the first serving peer;
at least part of the content item is included in a recording in the storage arrangement of the second serving peer; and
the recording of the first serving peer is different from the recording of the second serving peer based on a bit-to-bit comparison.

64. The system according to claim 63, wherein the content item stored in the storage arrangement of at least one of the first serving peer and the second serving peer is recorded from the media stream broadcast by the Headend.

65. The system according to claim 60, wherein the identifier is at least one of the following: an entitlement control message, a program clock reference, a group of pictures timecode, and an RTS timecode.

66. The system according to claim 60, wherein the first chunk is at least partially encrypted, the identifier not being encrypted.

67. The system according to claim 60, wherein once the first chunk is received, the content transfer module is able to serve the first chunk to the other peers.

68. The system according to claim 60, wherein the content transfer module is operative to receive the at least part of the first chunk from the first serving peer while the content item is still being received by the first serving peer from the Headend.

69. The system according to claim 60, wherein the communications network is an Internet protocol network.

70. The system according to claim 60, wherein the metadata module is operative to receive index metadata from the first serving peer, the system further comprising an indexer operationally connected to the metadata module, the indexer being operative to build, based on the index metadata, a random access index to at least part of the content item received by the content transfer module.

71. The system according to claim 60, wherein the requesting peer is associated with a storage arrangement having a subscriber section and an operator section, the subscriber section being operative to store the content item, wherein the system includes a deletion module operative to transfer the content item from the subscriber section to the operator section when a subscriber of the requesting peer requests to delete the content item.

72. The system according to claim 71, wherein the content item has a sharing expiration date, the deletion module being operative to delete the content item from the operator section on, or after, the sharing expiration date.

73. The system according to claim 60, further comprising an interactive search application to search for the content item based on event information data received in the media stream broadcast by the Headend.

74. The system according to claim 60, wherein:
the requesting peer is operative to receive the content item in the media stream broadcast by the Headend so that the content item is recordable by the requesting peer;
the requesting peer is associated with a storage arrangement to store at least part of the content item;
the system further comprises a correction sub-system to identify a bad/missing chunk of the content item, the first chunk being a replacement for the bad/missing chunk, the correction sub-system being operationally connected to the content transfer module;
the content transfer module is operative to receive the first chunk from at least one of the peers; and
the correction sub-system is operative to add the first chunk to the at least part of the content item stored in the storage arrangement associated with the requesting peer.

75. The system according to claim 74, wherein the correction sub-system is operative to automatically suggest, to a subscriber, recovery of the bad/missing chunk from at least one of the peers.

76. The system according to claim 74, wherein the missing chunk was not recorded by the requesting peer from the media stream broadcast by the Headend.

77. The system according to claim 74, wherein the bad chunk was received with an error by the requesting peer from the media stream broadcast by the Headend.

78. The system according to claim 74, wherein the requesting peer started recording the content item after the beginning of the content item, resulting in the missing chunk at the beginning of the content item.

79. The system according to claim 74, wherein the requesting peer stopped recording the content item before the end of the content item, resulting in the missing chunk at the end of the content item.

80. The system according to claim 74, wherein the content item is a pushed content item, pushed by the Headend, the missing chunk not being recorded by the requesting peer from the media stream broadcast by the Headend.

81. A content sharing system, for implementation in a requesting peer, to receive a first chunk from a first serving peer and a second chunk from a second serving peer, the first chunk and the second chunk being part of a content item, the requesting peer being operationally connected to a plurality of peers via a communication network, the peers including the first serving peer and the second serving peer, the first serving peer being associated with a storage arrangement which has a recording including at least part of the content item, the second serving peer being associated with a storage arrangement which has a recording including at least part of the content item, the recording of the first serving peer is different from the recording of the second serving peer based on a bit-to-bit comparison, the content item being media content originally broadcast in a media stream by a Headend to at least some of the plurality of the peers, the system comprising a content transfer module to:
request the first chunk from the first serving peer and the second chunk from the second serving peer; and
receive the first chunk from the first serving peer and the second chunk from the second serving peer.

82. A content sharing system, for implementation in a serving peer, to transfer at least a part of a first chunk to a requesting peer, the first chunk being part of a content item, the serving peer being operationally connected to a plurality of peers including the requesting peer via a communications network, the serving peer being associated with a storage arrangement in which the first chunk is stored, the content item being media content originally broadcast in a media stream by a Headend to at least some of the plurality of the peers, the system comprising:
a metadata module to receive chunk metadata identifying the location of the first chunk based on an identifier in the media stream originally broadcast by the Headend; and
a content transfer module operationally connected to the metadata module, the content transfer module being operative to:
receive a request to transfer the at least part of the first chunk to the requesting peer based on the chunk metadata; and
transfer the at least part of the first chunk to the requesting peer.

83. The system according to claim 82, wherein the content item stored in the storage arrangement of the serving peer was recorded from the media stream broadcast by the Headend.

84. The system according to claim 82, wherein the identifier is based on at least one of the following: an entitlement control message, a program clock reference, a group of pictures timecode, and an RTS timecode.

85. The system according to claim 82, wherein the content transfer module is operative to transfer the at least part of the first chunk to the requesting peer while the content item is still being received by the serving peer from the Headend.

86. The system according to claim 82, wherein the communications network is an Internet protocol network.

87. The system according to claim 82, wherein the serving peer is associated with a storage arrangement having a subscriber section and an operator section, the subscriber section being operative to store the content item, wherein the system includes a deletion module operative to transfer the content item from the subscriber section to the operator section when a subscriber of the serving peer requests to delete the content item.

88. The system according to claim 87, wherein the content item has a sharing expiration date, the deletion module being operative to delete the content item from the operator section on, or after, the sharing expiration date.

89. A system for enabling sharing of a content item among a plurality of peers, the peers being operationally connected via a communications network, the content item being media content originally broadcast in a media stream by a Headend to at least some of the plurality of the peers, the system comprising:
a content monitor to create a chunk metadata file which logically divides the content item into a plurality of chunks, such that each of the chunks is identified based on an identifier in the media stream originally broadcast by the Headend, the chunk metadata file being a separate file from the content item.

90. The system according to claim 89, further comprising a server, operationally connected to the content monitor and the peers, to serve the chunk metadata to the peers.

91. The system according to claim 89, wherein the content monitor is operative to forward the chunk metadata for inclusion in the media stream being broadcast by the Headend.

92. A content sharing system for implementation in a serving peer, the serving peer being operationally connected to a plurality of other peers via a communications network, the system comprising:
a content transfer module to transfer content between the serving peer and the other peers; and
a bandwidth allocation module to limit the time availability of the content transfer module to serve the content to the other peers.

93. A content sharing system for implementation in a serving peer being operationally connected to a plurality of other peers via a communications network, the system comprising:
a content transfer module to transfer content between the serving peer and the other peers;
a IPTV service module for receiving an IPTV service via the communications network; and
a bandwidth allocation module to decrease a download bandwidth allocated to the content transfer module when the IPTV service module is receiving the IPTV service.

94. An electronic program guide system, comprising an RSS reader application operative to:
link to an RSS feed having content item information for content items available for sharing among a plurality of peers;
check the RSS feed to see if the feed has new content item information since the last time the RSS feed was checked by the RSS reader;
retrieve the new content item information; and
present the new content item information in an electronic program guide.

95. The system according to claim 94, wherein the content items were previously broadcast by a Headend to the peers.

96. A method for managing access to a content item among a plurality of peers operationally connected via a communications network, access control to the content item being subject to a first business scenario when the content item is received from a broadcast media stream, the method comprising:
determining at least one new business scenario; and
associating the at least one new business scenario to the content item in order to define access control to the content item when the content item is shared among the peers via the communications network.

97. The method according to claim 96, further comprising generating at least one set of entitlement control messages for the content item for the at least one new business scenario.

98. A method for sharing a plurality of content items among a plurality of peers, the peers being operationally connected via a communications network, each of the content items associated with one of a plurality of TV channels, the content items being originally broadcast in a media stream by a Headend, the method comprising:
defining a plurality of different sharing rules, each of the sharing rules describing how an associated one of the content items is allowed to be shared among the peers; and
assigning one of the sharing rules to one of the TV channels and another one of the sharing rules to another one of the TV channels, so that the content items of the one channel are subject to the one sharing rule and the content items of the other channel are subject to the other sharing rule.

99. A content sharing method, for implementation in a requesting peer, to receive at least a part of a chunk from a serving peer, the chunk being part of a content item, the requesting peer being operationally connected to a plurality of peers including the serving peer via a communications network, the serving peer being associated with a storage arrangement in which the chunk is stored, the content item being media content originally broadcast in a media stream by a Headend to at least some of the plurality of peers, the method comprising:
receiving chunk metadata identifying the location of the chunk based on an identifier in the media stream originally broadcast by the Headend;
requesting the at least part of the chunk from the serving peer based on the chunk metadata; and
receiving the at least part of the chunk from the serving peer.

100. A content sharing method, for implementation in a requesting peer, to receive a first chunk from a first serving peer and a second chunk from a second serving peer, the first chunk and the second chunk being part of a content item, the requesting peer being operationally connected to a plurality of peers via a communication network, the peers including the first serving peer and the second serving peer, the first serving peer being associated with a storage arrangement which has a recording including at least part of the content item, the second serving peer being associated with a storage arrangement which has a recording including at least part of the content item, the recording of the first serving peer is different from the recording of the second serving peer based on a bit-to-bit comparison, the content item being media content originally broadcast in a media stream by a Headend to at least some of the plurality of the peers, the method comprising:
requesting the first chunk from the first serving peer and the second chunk from the second serving peer; and
receiving the first chunk from the first serving peer and the second chunk from the second serving peer.

101. A content sharing method, for implementation in a serving peer, to transfer at least a part of a chunk to a requesting peer, the chunk being part of a content item, the serving peer being operationally connected to a plurality of peers including the requesting peer via a communications network, the serving peer being associated with a storage arrangement in which the chunk is stored, the content item being media content originally broadcast in a media stream by a Headend to at least some of the plurality of the peers, the method comprising:
receiving chunk metadata identifying the location of the chunk based on an identifier in the media stream originally broadcast by the Headend;
receiving a request to transfer the at least part of the chunk to the requesting peer based on the chunk metadata; and
transferring the at least part of the chunk to the requesting peer.

102. A method for enabling sharing of a content item among a plurality of peers, the peers being operationally connected via a communications network, the content item being media content originally broadcast in a media stream by a Headend to at least some of the plurality of the peers, the method comprising:
receiving the content item; and
creating a chunk metadata file which logically divides the content item into a plurality of chunks, such that each of the chunks is identified based on an identifier in the media stream originally broadcast by the Headend, the chunk metadata file being a separate file from the content item.

103. A content sharing method for implementation in a serving peer being operationally connected to a plurality of other peers via a communications network, the method comprising:
transferring content between the serving peer and the other peers;
receiving an IPTV service via the communications network; and
decreasing a download bandwidth allocated to the content transfer when the IPTV service is being received.

104. An electronic program guide method, comprising:
linking to an RSS feed having content item information for content items available for sharing among a plurality of peers;
checking the RSS feed to see if the feed has new content item information since the last time the RSS feed was checked;
retrieving the new content item information; and
presenting the new content item information in an electronic program guide.
